(19) United States
(12) Patent Application Publication
(10) Pub. No.: US 2024/0235995 A1
(43) Pub. Date: Jul. 11, 2024

(54) VIRTUAL ROUTING AND FORWARDING USING IDENTICAL ANYCAST IDENTIFIERS ON EDGE DEVICES

(71) Applicant: Arista Networks, Inc., Santa Clara, CA (US)

(72) Inventor: Sunil Kumar Chandrashekhar Achar Suvarneshwar, Bengaluru (IN)

(21) Appl. No.: 18/151,444

(22) Filed: Jan. 8, 2023

(51) Int. Cl. H04L 45/586; H04L 45/50

(52) U.S. Cl. CPC H04L 45/586; H04L 45/50

(57) ABSTRACT

Virtual routing and forwarding techniques in a Virtual Routing and Forwarding (VRF) systems using a common base label and a common index are provided herein. An advertisement is received from a device external to the VRF system, the advertisement including an address of the device. Egress edge devices of the VRF system communicate to determine the common base label and the common index to be associated with the address. A data packet is received from a network device in the VRF system. A match is determined between an overlay label of the data packet and a label value corresponding to a combination of the common base label and the common index. A set of operations are performed modifying the overlay label based on the match. The modified data packet is sent to the device external to the VRF system.

### BACKGROUND

The present application relates to computer network technology and, more particularly, to virtual routing and forwarding.

In computer networks, virtual routing and forwarding (VRF) enables a plurality of network routes to be established between a pair of devices that are remotely located to each other. Network devices providing the network routes may maintain a plurality of routing tables that are used to route network communications between different pairs of devices. In some instances, multiple network routes between a pair of devices may be established for redundancy and load balancing purposes. When a network device or a connection in a network route is disrupted, a new set of routes may be determined, which may involve recalculating load balancing between devices, relabeling devices, and/or reconfiguring routes. As the size of a network grows, so too does the amount of computing resources involved in responding to and correcting for disruptions in VRF networks. In sufficiently large networks, the computing resources allocated to such corrections can become enormous.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 illustrates an example network topology in which a Virtual Routing and Forwarding (VRF) system mediates communications according to one or more embodiments.

FIG. 2 illustrates a portion of the example network topology of the VRF system of FIG. 1 that mediates communications according to one or more embodiments.

FIG. 3 illustrates the example network topology in which the VRF system of FIG. 1 mediates communications according to one or more embodiments.

FIG. 4 illustrates the example network topology in which the VRF system of FIG. 1 mediates communications according to one or more embodiments.

FIG. 5A illustrates example forwarding information base (FIB) information stored by an ingress provider edge device according to one or more embodiments.

FIG. 5B illustrates example vpn-ipv4/v6 network information stored by a router or ingress provider edge device according to one or more embodiments.

FIG. 5C illustrates example VFR label information stored by an egress provider edge device according to one or more embodiments.

FIG. 5D illustrates exemplary LFIB (underlay/tunnel) label information stored by non-EPE devices.

FIG. 6 illustrates the example network topology in which the VRF system of FIG. 1 mediates communications according to one or more embodiments.

FIG. 7 illustrates an example network topology in which a VRF system mediates communications between multiple external edge devices according to one or more embodiments.

FIG. 8A illustrates FIB information generated by sets of ingress edge devices based on communications between the egress edge devices according to one or more embodiments.

FIG. 8B illustrates example FIB information stored by one or more EPE routers of a VRF system according to one or more embodiments.

FIG. 8C illustrates example network information stored by an egress provider edge of a VRF system according to one or more embodiments.

FIG. 8D illustrates example VRF label information.

FIG. 8E illustrates example vpn-ipv4/v6 network information stored by a router or ingress provider edge device of a VRF system according to one or more embodiments.

FIG. 8F illustrates exemplary LFIB label information stored by non-EPE devices.

FIG. 8G illustrates exemplary LFIB label information stored by all devices in the service provider domain.

FIG. 9 illustrates an example network topology that includes a plurality of VRF systems according to one or more embodiments.

FIG. 10A illustrates example vpn-ipv4/v6 network information generated and stored by a router/ASBR when it receives 10C from another ASBR. This ASBR in turn generates FIG. 10E. FIG. 10E illustrates exemplary LFIB label information stored by ASBRs.

FIG. 10B illustrates example vpn-ipv4/v6 network information received and stored by a router/ASBR from an egress provider edge device according to one or more embodiments. ASBR which in turn generates FIG. 10C and FIG. 10D as mentioned in the operation of FIG. 10B. FIG. 10C illustrates example vpn-ipv4/v6 network information. FIG. 10D illustrates exemplary LFIB label information stored by ASBRs.

FIG. 11 illustrates a network device that is adapted to operate according to one or more embodiments of the present disclosure.

### DETAILED DESCRIPTION

### Overview

The present disclosure describes techniques and technology for allocating resources in VRF network topologies to provide node level redundancy. In the following description, for purposes of explanation, numerous examples and specific details are set forth to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Network virtualization is the ability to decouple the physical topology from a virtual topology using tunneling, for example. The physical topology or underlay network is the physical infrastructure that transports data packets across the network. The virtual topology or overlay network is built on top of the underlay network and is a virtual transport network of nodes and logical links where multiple layers of network abstraction can be created. The transport network is adapted to control the sequence of overlay nodes a data packet traverses before reaching its destination. By decoupling the underlay network from applications, network-wide virtualization can optimize computing and storage resources. Network virtualization has become a central part of network design for some organizations.

Virtual routing and forwarding (VRF) is a technology implemented in a computer networking environment that allows multiple instances of a routing table to exist simultaneously on the same network device. VRF is an extension of internet protocol routing and enables configuration of multiple routing table instances to simultaneously coexist within the same router. VRFs may provide network isolation/virtualization at Layer 3 of the Open Systems Interconnection (OSI) model as Virtual Local Area Networks (VLANs) serve at Layer 2. VRF techniques may involve the creation of Virtual Private Network (VPN) tunnels to be dedicated to a single network or client.

The VRF system disclosed herein involves determination, by edge devices of a VRF system, of a base label common among the edge devices, a unique index value specific to the VRF system, and an anycast next-hop address common among the edge devices. The base label and the index, together forming the anycast label for a VRF, and the anycast next-hop address help to provide redundancy among edge devices of the VRF system.

A plurality of egress provider edge (EPE) devices may be provided for redundancy in a routing instance of a VRF system connecting a pair of edge devices external to the VRF system. In some implementations, an ingress provider edge (IPE) device calculates a plurality of redundant paths through the VRF system that each include a different EPE. As a result of disruption associated with one of the EPEs, the IPE may need to recalculate the paths through the VRF system. As the size of VRF systems and the number of devices serviced grows, such recalculations may impose a significant hardware and computational burden on the IPE to determine equal-cost multi-path routes. Moreover, data packets can be lost due to the network disruptions despite recalculation of the network paths. The foregoing problem applies equally to gateway devices that connect two separate and independent VRF systems, such as those provided by two different entities.

The present disclosure provides synchronization of the base label, the index, and the anycast next-hop address for the edge devices of the VRF system. In connection with establishing a routing instance through the VRF system between a pair of external edge devices, a group of the EPEs communicate with each other to determine the common base value. The EPEs also communicate with each other to determine a unique index value to be combined with the common base label value to generate a unique label associated with an individual route but with their own unique next-hops. The EPEs may advertise the common base label, the index, and the common next-hop address to network devices in the VRF system, such as routers. The common base label, the index, and the common next-hop address are propagated to some nodes of the VRF system. As a result, the IPE encapsulates network traffic received from a first external edge device (e.g., a customer edge device) using a combination of the common base label and the index as a first overlay label.

A routing device receives the encapsulated packet and determines an EPE of the plurality of EPEs to send the data packet based on the first underlay label. The routing device removes the first underlay label and sends the data packet with the first overlay label to the EPE determined. If the routing device determines that a network connection between the routing device and the EPE is disrupted, the routing device sends the encapsulated data packet to another one of the EPEs. The EPE receives the encapsulated data packet from the router and determines that the data packet should be sent to the external edge device based on the overlay label. The EPE may modify the overlay label and may send the unencapsulated data packet over a network connection to the external edge device. If the network connection between the EPE and the external edge device is disrupted, the EPE may send the encapsulated data packet to a different EPE in the same group of EPEs. The different EPE may effectuate transmission of the data packet based on the first underlay label.

The foregoing techniques may be applied to gateway devices, which may receive an encapsulated data packet from a routing device. The gateway device(s) may encapsulate the data packet with a label provided by a gateway device of another VRF system and send the encapsulated data packet to the other gateway device. As a result, the gateway device of the different VRF system may receive and repackage the data packet with a different underlay label and/or a different overlay label. The gateway device may then route the re-encapsulated data packet through the other VRF system to an EPE device of the different VRF system, which then decapsulates the data packet and sends the data packet to the external edge device.

The terms “route” or “routing instance,” as used herein, refer to a collection of network segments through a VRF system between a pair of customer edge devices. Routes or routing instances may include a plurality of paths through the VRF system. The term “path,” as used herein, refers to a collection of network segments that includes a single EPE. A route, by contrast, may comprise a plurality of different paths through the VRF system. A route may include a set of equal cost multipaths (ECMPs) through the VRF system, the ECMPs each accruing the same “cost” to transfer a data packet from an ingress edge of the VRF system to an egress edge of the VRF system.

### System Architecture

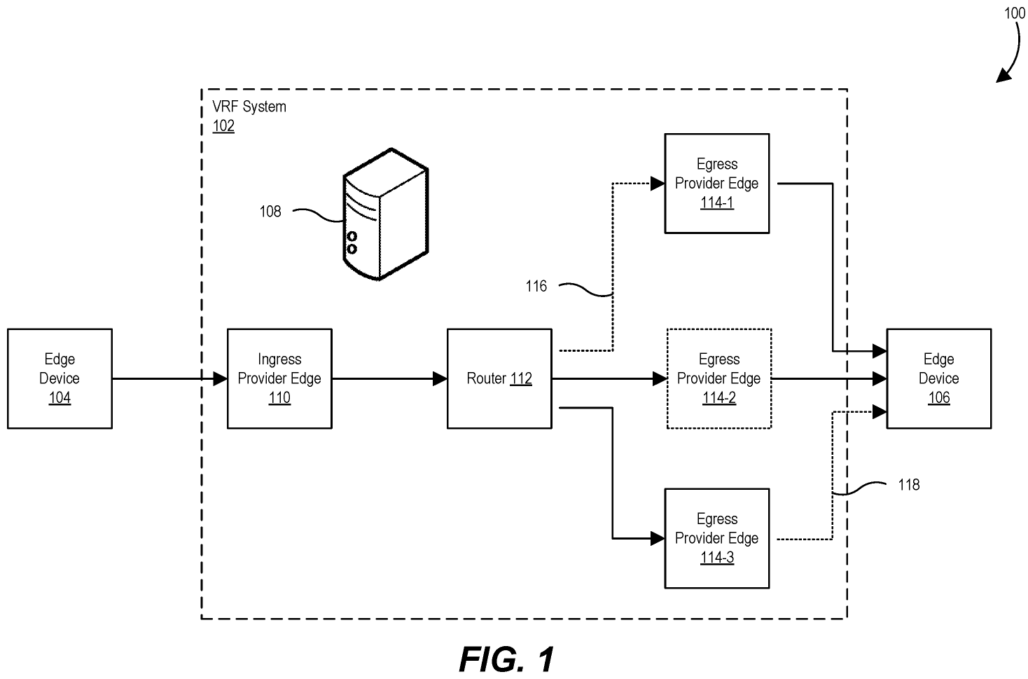

FIG. 1 illustrates an example network topology 100 in which a VRF system mediates communications according to one or more embodiments. The network topology 100 includes a VRF system 102 that mediates communications between a customer edge device 104 and a customer edge device 106 over one or more networks. The edge device 104 may be remotely located to the edge device 106 such that the edge devices 104 and 106 may be in different buildings, different regions, or different continents.

The VRF system 102 implements Multiprotocol Label Switching (MPLS) techniques in which network devices provide an underlay network for directing communications that include overlay data packets between the remotely located edge devices 104 and 106. The VRF system 102 may establish a routing instance in which labels are assigned to data packets and the labels are used as a basis for conveying the data packets through a plurality of network segments. Each network segment comprises a pair of network devices linked by a network connection established in an initiation session, e.g., using a Transmission Control Protocol.

The VRF system 102 may be provisioned by a third-party service provider (e.g., an internet service provider) external to the edge devices 104 and 106. The VRF system 102 may be provisioned using Border Gateway Protocol (BGP), an Open Shortest Path First (OSPF) protocol, Intermediate System to Intermediate System (IS-IS), an Enhanced Interior Gateway Routing Protocol (EIGRP), ISIS-SR, label Distribution Protocol (LDP), or another such routing protocol known to those skilled in the art. A processor-based device 108 (e.g., a controller) may instantiate the VRF system 102 as a result of a request provided by one or both of the edge devices 104 and/or 106. The processor-based device 108 may control various parameters associated with the VRF system 102, as described herein. The VRF system 102 includes multiple connections (e.g., VPN tunnels) for a given edge device to provide redundancy and load-balancing between devices of the VRF system 102.

The VRF system 102 includes a Label Switched Path (LSP) comprising an ingress provider edge (“IPE”) device 110, a router 112, and a set of egress provider edge (“EPE”) devices 114-1, 114-2, and 114-3 (collectively “egress provider edges 114” or “EPEs 114”). The IPE 110 is communicatively connected with the edge device 104 along a first edge of the VRF system 102. The IPE 110, for example, may be connected with the edge device 104 via a VPN tunnel. In some embodiments, the IPE 110 may be directly connected with the edge device 104 without intervening devices therebetween. The EPEs 114 are communicatively connected (e.g., via a VPN tunnel or may be directly connected) with the edge device 106 along a second edge of the VRF system 102. In connection with establishing the VRF system 102, a data structure is generated for each node in the VRF system 102 indicating routing or forwarding information. For instance, the IPE 110, the router 112, and the set of EPEs may store routing tables that provide information for routing and/or forwarding data packets in the VRF system 102. Non-limiting examples of such routing tables include routing information bases, forwarding information bases, and label forwarding information bases.

Communications between devices or nodes of the VRF system 102 and the edge devices 104 or 106 are according to a first communication protocol, such as Transmission Control Protocol/Internet Protocol (TCP/IP). By contrast, communications among the devices or nodes within the VRF system 102 are according to a second communication protocol, such as Border Gateway Protocol (BGP), Interior Gateway Protocol (IGP), or Label Distribution Protocol (LDP).

The ingress provider edge 110 is a network device (e.g., a router, network switch) that receives a data packet from the edge device 104. The IPE 110 compares IP header information in the data packet with information in a data structure (e.g., Routing table, FIB). The IPE 110 determines a label for the data packet based on the comparison. The IPE 110 adds an MPLS header to the data packet that includes the label determined. The IPE 110 transmits the data packet with the MPLS header to the router 112.

The router 112 is a hardware device constituting a network node that reflects routes or forwards data packets between network devices of the VRF system 102. Non-limiting examples of the term “router,” as used herein, include label switching routers, route reflectors, or other similar devices operating as intermediary nodes between ingress provider edge devices and egress provider edge devices (e.g., between IPE 110 and the EPEs 114). The router 112 exchanges routing information for other internal peers in the VRF system 102. The router 112, for instance, advertises information regarding routes associated with the EPEs 114 to the IPE 110. The router 112 also advertises information regarding routes associated with the IPE 110 to the EPEs 114. The router 112 stores, in memory, a data structure (e.g., a Label Information Base) in which individual labels of a first set of MPLS labels are associated with individual labels of a second set of MPLS labels for the VRF system 102. It is understood that there may be more than one router between the IPE 110 and the EPEs 114.

The router 112 receives, from the IPE 110, the data packet with the label and determines a new label associated with the label received based on an association referenced in the data structure. The router 112 replaces the label on the data packet with the new label determined. The router 112 sends the data packet with the new label to an EPE 114-1 of the set of EPEs 114 corresponding to the new label. Those of skill in the art will appreciate that a LSP may include more than one router 112 between the IPE 110 and the EPEs 114. The EPE 114-1 receives the data packet with the new MPLS label and removes the MPLS label from the data packet. The EPE 114-1 sends the data packet to the edge device 106 according to the first communication protocol (e.g., IPv4, IPv6).

Several issues may arise that affect operation of the VRF system 102. A tunnel between the router 112 and the EPE 114-1 may be disrupted or discontinued, for instance. Another potential issue is that operation of the EPE 114-2 may experience a disruption (e.g., outage). A further potential issue is that a connection 118 between the EPE 114-3 and the edge device 106 may be disrupted or discontinued. Such issues may prevent or inhibit a data packet from the edge device 104 to reach the edge device 106 via an intended LSP for a given data packet.

As a result of detecting the occurrence of a disruption in the VRF system 102, such as the aforementioned issues, the IPE 110 may determine and establish a different set of LSPs through the VRF 102 for load-balancing or redundancy purposes. Significant computational resources may be involved in determining a different set of paths, which may impact performance of the VRF system 102, e.g., in mediating communications between other edge devices external to the VRF system 102. As the size and complexity of the VRF system 102 grows to provide routing and forwarding services to external edge devices, so too do the computational resources involved in determining the new set of paths to address issues disrupting operation of the VRF system 102.

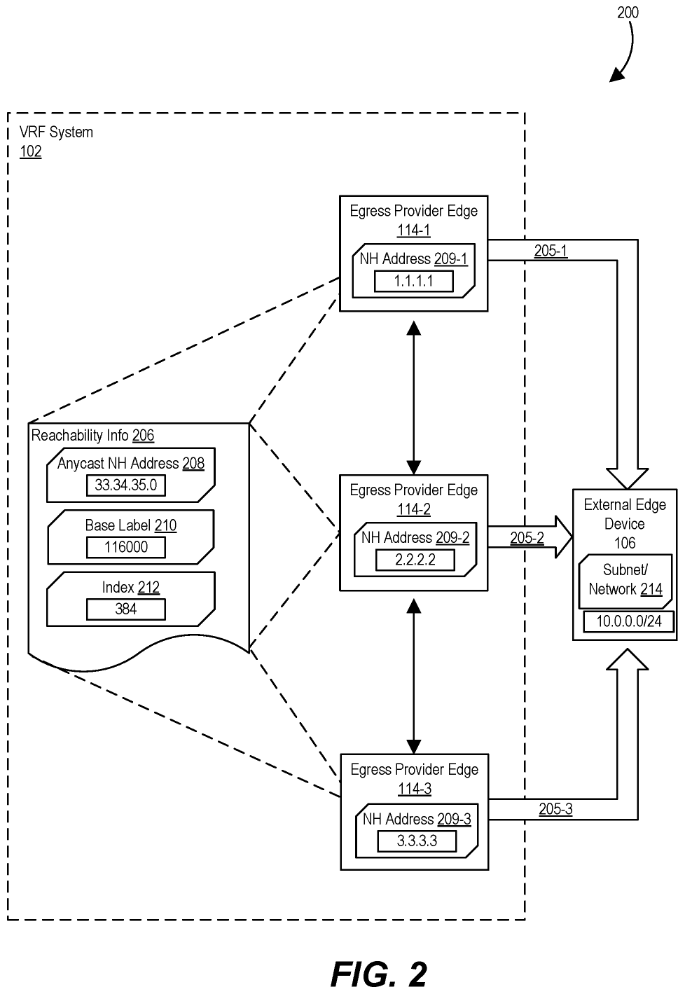

FIG. 2 illustrates a network topology 200 that includes a portion of a VRF system 102 that mediates communications according to one or more embodiments. The VRF system 102 includes a set of egress provider edge devices (EPEs) 114-1, 114-2, 114-3 (collectively “egress provider edges 114” or “EPEs 114”) that send communications to customer edge devices external to the VRF system 102, as described in FIG. 1 and elsewhere herein. The EPEs 114 determine reachability information 206 to be advertised to other nodes of the VRF system 102 for the one or more paths. Although three egress provider edges 114 are shown and described with respect to FIG. 2, it is understood that the number of EPEs 114 may be more or less than three in some embodiments.

The EPEs 114-1, 114-2, 114-3 may respectively establish border gateway protocol (BGP) communication sessions 205-1, 205-2, and 205-3 (collectively “BGP communication sessions 205” or thru any static or dynamic routing protocols) with external edge device 106 according to one or more communication protocols. The external edge device 106 may be a device of a customer of a service provider that owns, operates, or otherwise exercises control over the VRF system 102. The EPEs 114 may establish the BGP communication sessions 205, e.g., based on a neighbor statement. The IP network/subnet 214 (10.0.0.0/24) is a network advertised over BGP or any other communicating protocol such as OSPF/ISIS, etc., by the external edge device 106 in this non-limiting example. The EPEs 114 may determine at least some of the reachability information 206 as a result of establishing the BGP communication sessions 205. The BGP communication sessions 205 are, in some embodiments, external BGP (EBGP) sessions established according to an EBGP communication protocol.

The reachability information 206 determined by the EPEs 114 includes the prefix, a common anycast next-hop address 208, a common base label 210 (applies for the device), and an index 212. The anycast next-hop address 208 (reachable within VRF system 102) may be formatted according to a Layer 2 or a Layer 3 communication protocol, such as IPv4, IPV6, or VXLAN, by way of non-limiting example. The common base label 210 is a label formatted according to a Layer 3 communication protocol, such as those associated with MPLS (e.g., BGP, IGP). The index 212 is an offset value to be combined with the common base label 210. The index 212 is specific to the VRF instance associated with the external edge device 106. The group of EPEs 114 may determine a different index 212 for a VRF instance associated with a different customer; however, the base label 210 is specific to the group of EPEs 114 in some embodiments.

The EPEs 114 may exchange communications with RR/IPE (e.g., via the control plane) to determine the anycast next-hop address 208, the common base label 210, and the index 212. The EPEs need to be provisioned with the same next-hop address, base label and the same unique index for a VRF. In some embodiments, the anycast next-hop address 208 may be formatted according to an IPV4 or IPv6 communication protocol.

The EPEs 114 synchronize or coordinate the anycast next-hop address 208, the base label 210, and the index 212 using one or more communication protocols, such as Border Gateway Protocol Segment Routing (BGP-SR). In the network topology 200 shown, the value of the anycast next-hop address 208 is 33.34.35.0, the value of the base label 210 is 116000, and the value of the index 212 is 384. As a result of establishing the anycast next-hop address 208, the common base label 210, and the index 212, the EPEs 114 store the reachability information 206 in local memory (e.g., read-only memory) to be used for communications in a specific path through the VRF 202. The anycast next-hop address 208, the common base label 210, and the index 212 may be stored by the EPEs 114 in association with an identifier of the specific route established or to be implemented. The EPEs 114 each store the same address 208 and the same common base label 210 for the specific route. The EPEs 114 each have a unique next-hop address 209 that is specific or unique to the egress provider edge. EPE 114-1, for example, has a next-hop address 209-1 with a value of 1.1.1.1; EPE 114-2 has a next-hop address 209-2 with a value of 2.2.2.2; and EPE 114-3 has a next-hop address 209-3 with a value of 3.3.3.3. In an embodiment, unique NHs would be advertised by the EPEs with other members of the EPE group with the IBGP mesh created between the EPEs to handle the network disruptions but with the same base label 210 and index 212. This path will become active depending on the BGP best path algorithm (or when used as backup path).

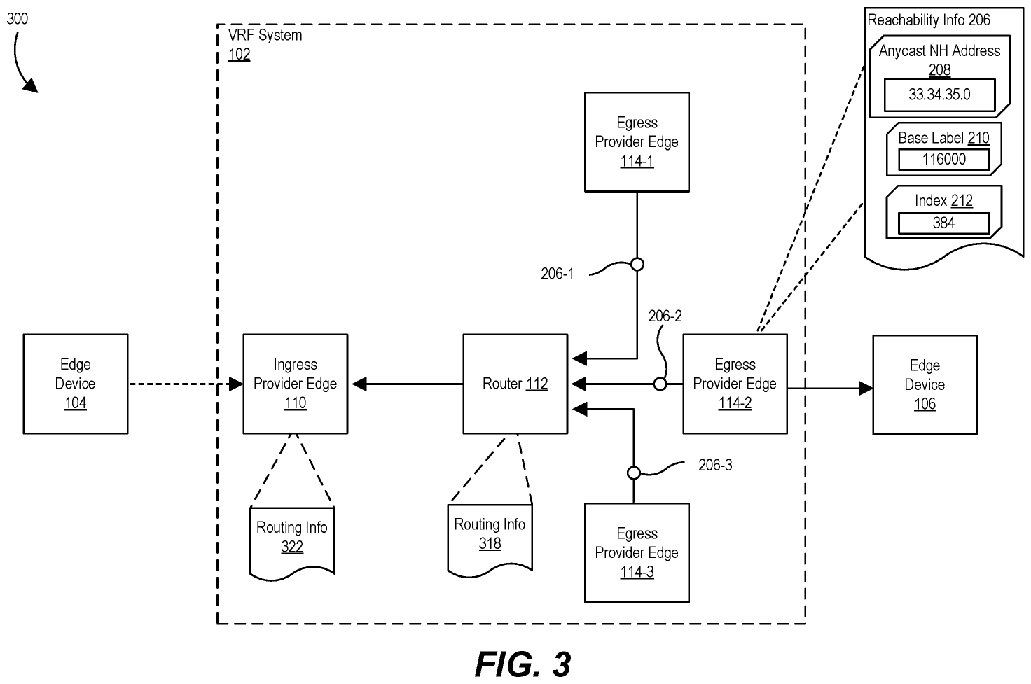

FIG. 3 illustrates routing and reachability information an example network topology 300 in which a VRF system mediates communications according to one or more embodiments. The network topology 300 includes a VRF system 102 that mediates communications between a customer edge device 104 and a customer edge device 106 over one or more networks as described above. The VRF system 102 includes egress provider edge devices 114-1, 114-2, 114-3 (collectively “EPEs 114”) provided on an edge of the VRF system 102. The EPEs 114 advertise reachability information 206 to one or more peers in the VRF system 102, such as a router 112. The reachability information 206 may be advertised as a Layer 3 communication, such as a communication provided over a control plane of a network of the VRF system 102. The EPEs 114 implement a VRF instance that is specific to a customer (e.g., edge device 106 of FIG. 2).

The reachability information 206 advertised includes an anycast next-hop address 208, a base label 210, and an index 212, which are determined as described with respect to FIG. 2. The reachability information 206 may include an identifier of a route with which the reachability information 206 is associated. The anycast next-hop address 208, in some embodiments, may have a format according to a Layer 2 or a Layer 3 communication protocol, such as IPv4, IPv6, or VXLAN. In some embodiments, the anycast next-hop address 208 is provided as a remote-next hop address in a specified path. The base label 210 and the index 212 may be formatted according to an MPLS protocol, such as BGP or IGP. The reachability information 206 includes information that is specific to the VRF's customer (external edge device 106), such as the anycast next-hop address 208 and/or the index 212.

The reachability information 206 advertised to the router 112 by each of the EPEs 114 includes the same next-hop address 208, the same base label 210, and the same index 212. Reachability information 206-1 is advertised by the EPE 114-1 in connection with a routing instance between a pair of customer edge devices (e.g., edge devices 104 and 106). Reachability information 206-2 is advertised by the EPE 114-2 in connection with a routing instance between the pair of customer edge devices. Reachability information 206-3 is advertised by the EPE 114-3 in connection with a routing instance between the pair of customer edge devices. The reachability information 206-1, 206-2, 206-3 includes the anycast next-hop address 208, the base label 210, and the index 212. In some embodiments, the reachability information 206 may be provided to the router 112 by the EPEs 114 in response to a request from the router 112 for such reachability information.

In some embodiments, the EPEs 114 may provide next-hop addresses specific to the EPEs to the router 112 and/or the IPE 110. For instance, with reference to FIG. 2, EPE 114-1 may provide the next-hop address 209-1, EPE 114-2 may provide the next-hop address 209-2, and EPE 114-3 may provide the next-hop address 209-3. In some embodiments, the EPEs 114 may provide the EPE specific next-hop addresses to the router 112 and/or the IPE 110 as part of or in connection with the reachability information 206. In some embodiments, the EPEs 114 provide the EPE specific next-hop addresses prior to provisioning the reachability information 206 or in a process separate from generating and provisioning the reachability information 206. The router 112 and/or the IPE 110 may use the EPE-specific next-hop addresses, at least in part, to distinguish between the EPEs 114.

The router 112 receives the reachability information 206-1, 206-2, 206-3 provided by the EPEs 114 and updates routing information 318 regarding the path to be implemented between the edge devices 104 and 106. In some embodiments, the routing information 318 updated is routing information included in a data structure, such as a routing table, a forwarding information base (FIB), a label forwarding information base (LFIB), a routing information base (RIB), or other similar data structure. Updating the routing information 318, in some implementations, may include generating a data structure and including the reachability information 206-1, 206-2, 206-3 as routing information 318 in the data structure. Updating the routing information 318 may include storing information specific to the EPEs 114 in association with the reachability information 206-1, 206-2, 206-3, such as information of the EPE 114-1, 114-2, 114-3.

The router 112 may advertise, to an ingress provider edge device 110 of the VRF system 102, the routing information 318 that includes at least some of the reachability information 206. The ingress provider edge device 110 may update routing information 322 based on the routing information 318 provided. Updating the routing information 322 may include updating a data structure to include at least the prefix, base label 210, and index 212 (base label+index forms the anycast label) provided by the router 112. The router 112 may advertise at least some of the reachability information 206 to the ingress provider edge 110 or other routers according to an appropriate communication protocol, such as Label Distribution Protocol (LDP) or BGP. The VRF system 102 may synchronize routing information, such as a common MPLS label of the EPEs 114 or BGP Prefix Segment Identifiers, among the IPE 110, the router 112, and/or the EPEs 114 using techniques documented by the Internet Engineering Task Force. Non-limiting examples of such techniques include RFC 8669 (last updated Sep. 9, 2021), RFC 4760 (last updated Jan. 21, 2020), and RFC 8277 (last updated Oct. 19, 2017).

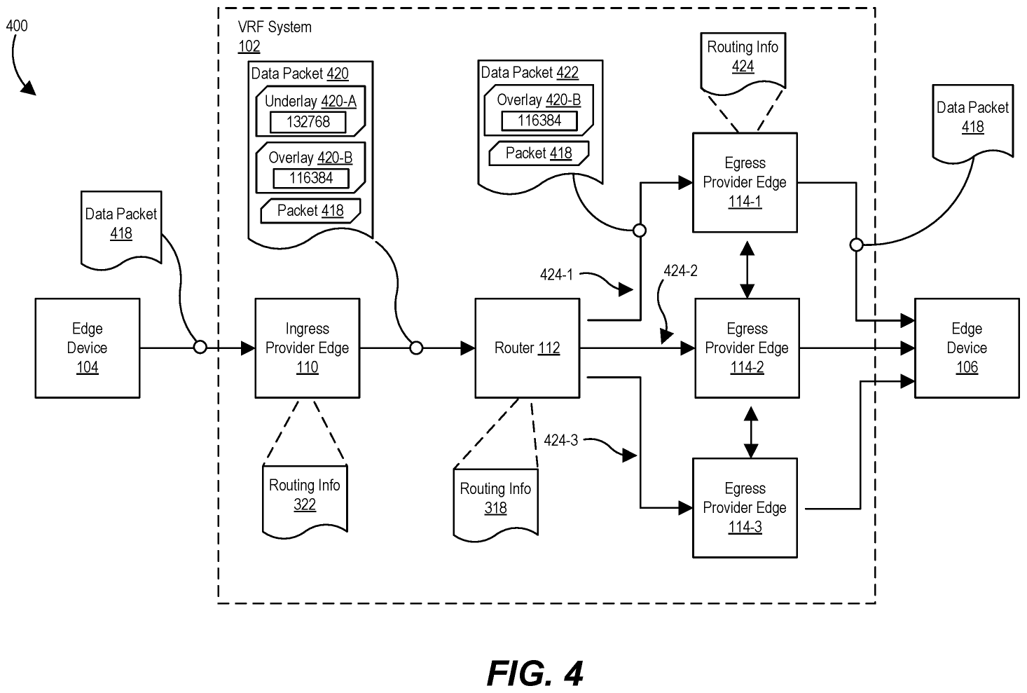

FIG. 4 illustrates routing a packet using an example network topology 400 in which a VRF system mediates communications according to one or more embodiments. A VRF system 102 establishes a route through which a customer edge device 104 and a customer edge device 106 can communicate as described above. The route includes a set of LSPs through which the VRF 102 can route encapsulated data packets using MPLS routing information, as described herein. The VRF system 102 implements Multiprotocol Label Switching techniques in which VPNs provide Internet Protocol (e.g., IPv4, IPv6) services to the remotely located edge devices 104 and 106.

The route established by the VRF system 102 includes an ingress provider edge device 110, a router 112, and egress provider edge devices 114-1, 114-2, 114-3 (collectively “EPEs 114”). The ingress provider edge 110 stores routing information 322 in a data structure, such as a routing table or a Routing Information Base (RIB). The routing information 322 includes information associated with the set of paths of the routing instance, such as a plurality of MPLS labels that correspond to a routing instance associated with the EPEs 114. The routing information 322 further includes one or more common anycast next-hop addresses 208 provided by the EPEs 114.

The router 112 also stores routing information 318 in a data structure, such as a routing table or a Label Forwarding Information Base (LFIB). The routing information 318 may also include information associated with the set of paths of the routing instance, such as labels advertised by the EPEs 114. In some embodiments, the routing information 318 may include a common anycast next-hop address 208 provided by the EPEs 114, the common anycast next-hop addresses 208 corresponding to a group of EPEs providing redundancy. The router 112 may advertise the common anycast next-hop address 208 to the IPE 110 in connection with the labels advertised by the EPEs 114.

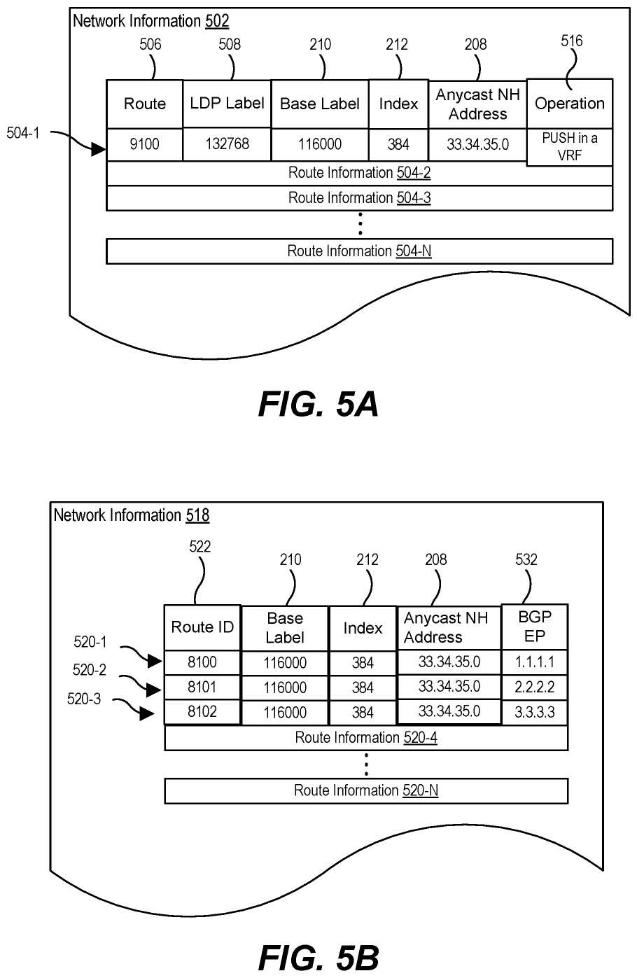

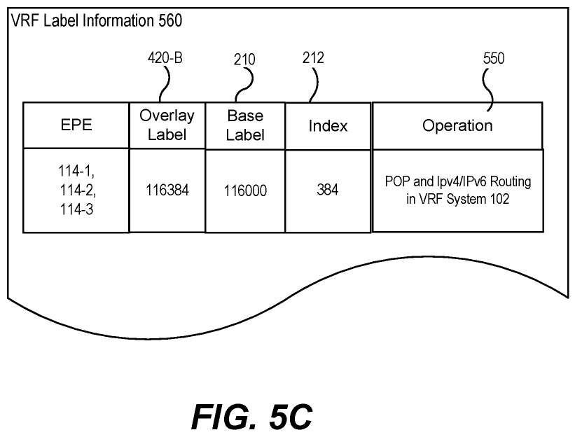

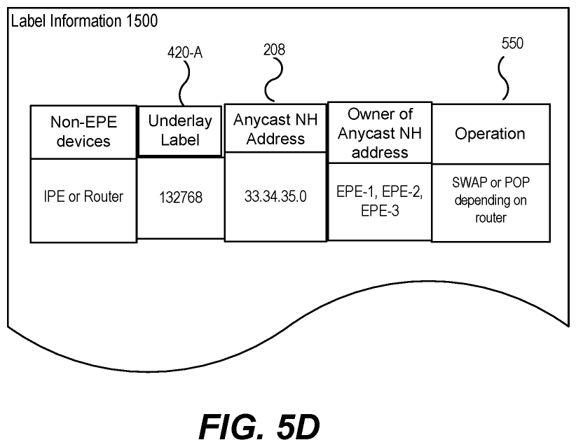

FIG. 5A illustrates example network information 502 that may be stored by an ingress provider edge device 110 according to one or more embodiments. The network information 502 may include reachability information and/or routing information, as described herein. The network information 502 includes one or more sets of path information 504-1, 504-2, 504-3 . . . 504-N regarding LSPs established by the VRF system 102. The sets of path information 504 may include a route 506, an LDP label 508, a base label 210, an index 212, an anycast next-hop address 208, and/or information indicating an operation 516 to be performed involving a received data packet. The route information 504-1, 504-2, 504-3 . . . 504-N may include additional information or exclude some of the information in the network information 502 in some embodiments. In some embodiments, entries in the network information 502 may include a plurality of routing tables for distribution of VRF/VPN routing information. Each routing table may include an IP-formatted address prefix (e.g., IPv4 address, IPv6 address) and a subnet mask—for instance, a BGP routing table may be associated with an IPV4/mask of 10.0.0.0/24. Some of the path information shown in 504-1 may be stored in different tables or arrays in some embodiments.

The route 506 identifies a route established to facilitate communications between customer edge devices, such as the edge devices 104 and 106. The route 506 may have a format that includes an IP/IPV6 address. The LDP label 508 is an MPLS label generated according to the Label Distribution Protocol. The LDP label 508 is an identifier specific to the EPEs 114. For instance, the LDP label 508 has a value of 132768 and may correspond to the anycast next-hop address 208 (33.34.35.0) of the EPE 114-1 in FIG. 2. FIG. 5A illustrates FIB information 502 that combines the label information 1500 of FIG. 5D and the routing information 518 of FIG. 5B. For example, in FIG. 5B Route ID would include the route distinguisher and target identifier may be as follows:

$$81 \; 00 = RDe 1 : 10. \text{.0} \text{.0} / 24 + RT 1$$

$$8101 = RD e 2 : 10.0. \text{.0} / 24 + RT 1$$

$$8102 = RD e 3 : 10.0. \text{.0} / 24 + RT 1$$

$$8200 = RDe 1 : 10. \text{.0} \text{.0} / 24 + RT 2$$

$$8201 = RD e 2 : 10.0. \text{.0} / 24 + RT 2$$

$$8202 = RD e 3 : 10.0. \text{.0} / 24 + RT 2$$

$$8103 = 8100$$

$$8104 = 8101$$

$$8203 = 8200$$

$$8204 = 8201$$

The base label 210 and the index 212 together make up an MPLS label advertised to the IPE 110 by the router 112, as described with respect to FIG. 3. In some embodiments, the base label 210 and the index 212 are stored as different entries in a routing table. In some embodiments, the base label 210 and the index 212 are combined into a single value (e.g., 116384) and stored in a routing table.

Different routes through the VRF system 102 may have different sets of path information. A single instance of path information associated with a single route, however, may include information associated with a plurality of paths through the VRF system 102. For instance, an overlay label generated based on the path information 504-1 in FIG. 5A, for instance, has a value of 116384 that corresponds to a routing instance comprising a plurality of paths that each include one of the EPEs 114 in FIG. 5B. The overlay label generated based on the path information 504-1 may correspond to a combination of the common base label 210 and the index 212. More specifically, an overlay label 116384 generated based on the path information 504-1 may correspond to the value 384 of the index 212 added to the value 116000 of the common base label 210 (see FIG. 2), as included in the reachability information 206 discussed with respect to FIG. 3.

The path information 520-1 further includes the next-hop address 208 advertised by the EPEs 114 to the router 112 in connection with advertisement of the base label 210 and the index 212, as also described with respect to FIG. 3. The anycast next hop address 208 has an VPN-IPV4/V6 NH address format, such as “RD+33.34.35.0”, but only “33.34.35.0” is considered for brevity as shown in FIG. 5B. The operation information 516 in the path information 504-1 indicates an MPLS operation to be performed for data packets received from the edge device 104 that matches route 506 in FIB. 504-1 is derived from path information 520-1, 520-2, 520-3 of 5B along with FIG. 5D. Thus, path information 504-1 is not an equal cost multi-path (ECMP) in the forwarding information base (FIB).

The IPE 110 routes encapsulated data packets through established paths in the VRF system 102 based on the network information 502. In previous implementations, an IPE may perform load-balancing operations, such as a set of hashing operations, to select a path through the VRF system 102 to route a data packet received. In such implementations, in response to a network disruption associated with one of the EPEs, the IPE would recompute or recalculate the ECMPs through the VRF system. Additionally, the IPE would store a different MPLS label generated according to BGP for each EPE.

By contrast, the VRF system 102 reduces the computational resources involved in obviating or responding to a network disruption associated with one or more of the EPEs 412. If operation of one of the EPEs 114 or a network connection in the VRF system 102 to the EPEs 114 is disrupted, though IPE 110 recomputes the path, as long as even one path is available, the FIB will remain the same on the IPE in the VRF system 102. Therefore, an encapsulated packet sent by the IPE 110 to one of the EPEs 114 will still reach the edge device 106. Moreover, the network information 502 maintained by the IPE 110 includes the same overlay/service/VRF label 116384 for all of the EPEs 114 associated with the route 506 in the path information 504-1. As described herein, the router 112 performs load-balancing operations for the route including the paths through the EPEs 114 instead of the IPE 110.

FIG. 5B illustrates example network information 518 that may be stored by an IPE or RR according to one or more embodiments. The network information 518 may include reachability information and/or routing information, as described herein. The network information 518 includes one or more sets of path information 520-1, 520-2, 520-3, 520-4, . . . 520-N regarding LSPs established by the VRF system. The sets of path information 520-1, 520-2, 520-3, 520-4, . . . 520-N may each include a route identifier 522, an LDP label 524, a base label 210, an index 212, an anycast next-hop address 208, and/or a BGP endpoint identifier 532.

In some embodiments, the base label 210 and the index 212 may be combined into a single entry in each path information 520-1, 520-2, 520-3, 520-4, . . . 520-N. For instance, the path information 520-1, 520-2, 520-3, 520-4, . . . 520-N may each include a single entry in which the base label 210 is combined with the index 212, resulting in a value of 116384. The router 112 in the data path, in some implementations, performs load-balancing or forwards the data packet(s) received from the IPE 110 using the LDP label 508 or 420-A of Label information 1500.

In some embodiments, each instance of the path information 520 may include an identifier of one of the EPEs 114. An example of such an identifier is the BGP endpoint 532, tied with the unique next-hop addresses 209 discussed with respect to FIG. 2. The EPE identifier is useable by the router 112 to identify with which of the EPEs 114 the particular instance of the path information 520 is associated. For instance, the path information 520-1 may include an identifier associated with the EPE 114-1, the path information 520-2 may include an identifier associated with the EPE 114-2, and the path information 520-3 may include an identifier associated with the EPE 114-3. In some embodiments, the EPE identifier includes information specific to the individual EPE, such as a MAC address or a network segment identifier. The router 112 may use the EPE identifier to differentiate between the EPEs 114.

In some embodiments, entries in the network information 502 may include a plurality of routing tables for distribution of VRF/VPN routing information. Each routing table may include an VPN IPV4/V6-formatted address prefix (e.g., IPv4 address, IPv6 address) and a subnet mask—for instance, a BGP routing table may be associated with an IPV4/mask of 10.0.0.0/24. Some of the path information shown in path information 504-1 may be stored in different tables or arrays in some embodiments.

The route identifier 522 identifies a route established to facilitate communications between customer edge devices, such as the edge devices 104 and 106. The route identifier 522 may have a format that includes a VPN IPv4/IPV6 address and a route target identifier as per RFC 4364 (e.g., 8100=RDe1:10.0.0.0/24+RT1, 8101=RDe2:10.0.0.0/24+RT1, 8102=RDe3:10.0.0.0/24+RT1). A route wherever referred is the actual IPV4/IPV6 prefix derived from route ID by stripping of the RD and RT.

FIG. 5C illustrates example VFR label information 560 that may be stored by an egress provider edge device 114 according to one or more embodiments. The VFR label information 560 may include overlay label 420-B. Overlay label 420-B may be created by a combination of the base label 210 and the index 212. Based on the information in the overlay label 420-B, the EPE 114 will perform an operation 550, such as IPv4/IPv6 routing in VRF system 102.

FIG. 5D indicates the Label Information Base that gets populated by label distribution protocols like LDP or ISIS-SR. The label to reach the anycast NH 208 (33.34.35.0) would be underlay 420-A (132768).

Referring back to FIG. 4, the VRF system 102 establishes a routing instance for communications between the edge device 104 and the edge device 106. The routing instance has network segments that include the IPE 110, the router 112, and the EPEs 114. The IPE 110 and the router 112 (acting as LSR) respectively utilize the routing information 322 and 318 described with respect to FIGS. 5A and 5D to route data packets through the routing instance.

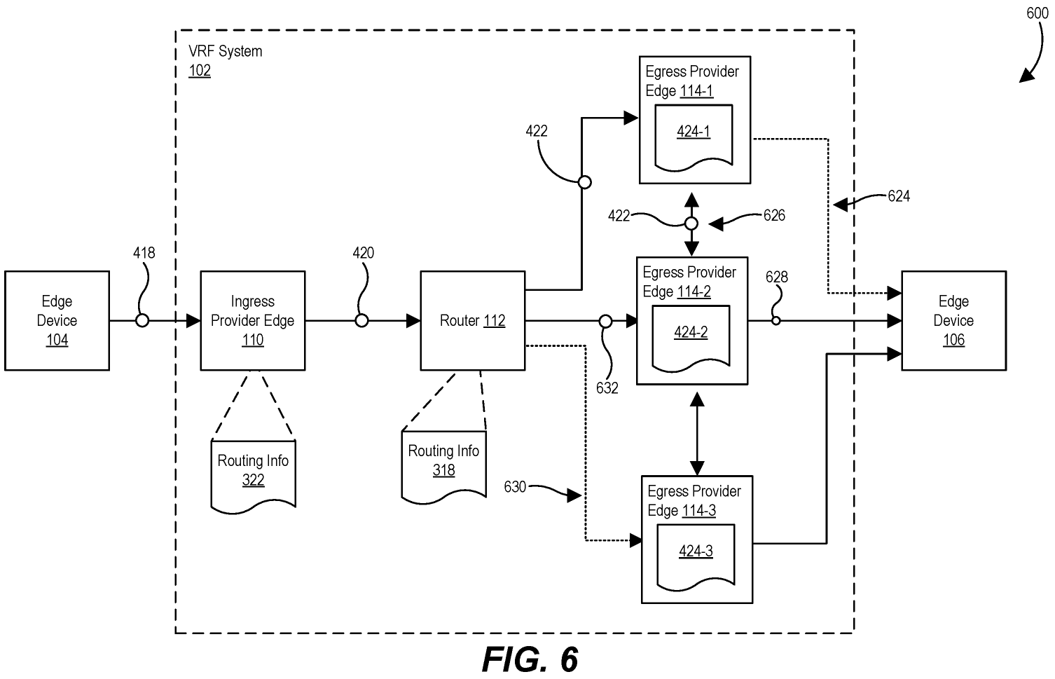

Those skilled in the art will appreciate that the techniques described herein may be implemented without a router, a route reflector, and/or or a label switching router. For instance, the VRF system 102 may be implemented without the router 112. In such implementations, the data packet 422 having the overlay 420-B may be sent from the IPE 110 to the EPE 114-1 without the underlay 420-A. Substantially similar modifications may apply to the VRF systems 102, 702, 902, and/or 908, as described with respect to FIGS. 6, 7, and 9 infra.

Subsequent to establishing a routing instance, the ingress provider edge 110 receives, over the routing instance, a data packet 418 from the edge device 104. The data packet 418 includes a header and a payload. The header includes a destination address advertised by the edge device 106 and may be formatted according to one or more protocols, such as IPv4, IPV6, or VXLAN, such as 10.0.0.0/24.

The IPE 110 determines, based on the routing information 322, that the destination address is associated with a next hop of the routing instance, such as the anycast next hop address 208 advertised by the EPEs 114, as discussed with respect FIG. 3. The IPE 110 determines an MPLS label to apply based on the anycast next hop address 208. More particularly, the IPE 110 determines that the path information 504-1 includes route 506 matching the address provided in the header of the data packet 418.

Based on the match between the address in the header and the IPV4/IPV6 address of route 506 in the path information 504-1 in the FIB, the IPE 110 generates an encapsulated data packet 420 that includes the data packet 418 and an MPLS Layer 2 frame. Generating the encapsulated data packet 420 includes encapsulating the data packet 418 with an underlay label 420-A and an overlay label 420-B based on the path information 504-1. The underlay label 420-A is an MPLS label generated according to LDP. To generate the overlay label 420-B, the IPE 110 combines or adds the base label 210 and the index 212 of the path information 504-1. As described herein, the base label 210 and the index 212 are reflected to the IPE 110 by the router 112.

The router 112 receives the encapsulated data packet 420 and performs a set of operations to select an EPE of the EPEs 114 to which to send a data packet 422. The router 112, more particularly, refers to the routing information 318 to determine a label switching operation to be performed on the data packet 420 and a destination for a data packet 422 resulting from the label switching operation. In some implementations, the label switching operation may include a POP operation in which the underlay 420-A is removed to reveal the overlay 420-B. In some implementations, the label switching operation includes a SWAP operation in which the underlay 420-A is exchanged with a different underlay label in the routing information 318.

In the VRF instance implemented in the VRF system 102 for communications between the edge devices 104 and 106, the router 112 performs a POP operation to remove the underlay 420-A. The router 112 performs a load-balancing technique to select an EPE among the EPEs 114 to which the encapsulated packet 420 will be sent based on LFIB (based on label information 1500), which is outside the scope of this document. Non-limiting examples of such load-balancing techniques include hash-based ECMP techniques, round robin ECMP techniques, and weighted ECMP techniques. In connection with performing a hash based ECMP technique, the router 112 may select a hashing key of a plurality of hashing keys stored in memory of the router 112 to use in a given hashing operation.

The encapsulated packet 422 includes an overlay 420-B, which in this particular non-limiting example, has a value of 116384. The data packet 422 includes the data packet 418 encapsulated in an MPLS frame. The router 112 forwards the data packet 422 to the EPE 114-1.

The EPE 114-1 receives the encapsulated packet 422 from the router 112. The EPE 114-1 determines one or more operations to be performed and a destination for the data packet 422 based on the overlay label 420-B. In some embodiments, the EPE 114-1 determines a destination address of a data packet based on a comparison between the overlay 420-B and routing information 424 stored in memory of the EPE 114-1, as seen in FIG. 5C. The EPE 114-1 may, for instance, remove the overlay label 420-B and send the data packet 418 to the edge device 106 according to a defined communication protocol, such as IPv4 or IPv6 based on the FIB (Not depicted in any of the diagrams which is pure IPV4/V6 routing/forwarding).

The VRF systems described herein are more robust to mitigate network disruptions associated with the EPEs. FIG. 6 illustrates an example network topology 600 in which a VRF system 102 mediates communications according to one or more embodiments with respect to routing during network disruptions. The features described with respect to the network topology 600 are substantially similar to those described with respect to the network topology 400, so further description thereof is omitted for brevity.

A router 112 sends an encapsulated data packet 422 to an EPE 114-1. In the network topology 600, a network connection 624 between the EPE 114-1 and an edge device 106 is disrupted (e.g., experiences an outage). In previous implementations, an IPE would recalculate routes and/or paths (e.g., ECMPs) through a VRF system in response to a network disruption associated with the EPEs 114. However, the VRF system 102 is adapted to operate despite such disruptions without imposing computational burdens on hardware of an IPE 110 of the VRF system 102.

In the VRF system 102, the EPEs 114-1, 114-2, 114-3 are configured to communicate with each other through IBGP mesh, which advertises the prefixes with their own nexthop address, to transmit data packets to the edge device 106 as a result of detecting a disruption in a network connection with the edge device 106. For instance, the router 112 receives an encapsulated data packet 420 and selects EPE 114-1 as a recipient for a data packet 422, as described with respect to FIG. 4. The EPE 114-1 receives the data packet 422 from the router 112 having an overlay label or service label corresponding to the overlay label 420-B. The EPE 114-1 may decapsulate the data packet 422 in some embodiments by removing the overlay label of the data packet 422 (e.g., overlay 420-B of FIG. 4). The EPE 114-1 determines the data packet 422 should be sent to the edge device 106 based on routing information 424-1 stored in memory/FIB of the EPE 114-1. The routing information 424 includes the reachability information 206 described with respect to FIG. 3.

The EPE 114-1 determines that a network connection 624 between the EPE 114-1 and the edge device 106 is unavailable (e.g., due to a network disruption). In response to the determination that the network connection 624 is unavailable, the EPE 114-1 may reference the routing information 424-1 and determine that the EPE 114-2 and the EPE 114-3 are also associated with a same VRF instance for the data packet 422. As a result of detecting the match, the EPE 114-1 sends the data packet 422 to the EPE 114-2 over a network connection 626 between the EPEs 114-1 and 114-2 or it could go through the router 112 again. Before sending the data packet 422 to the EPE 114-2, the EPE 114-1 may re-encapsulate the data packet 422 with the overlay label the EPE 114-1 previously removed. For instance, with reference again to FIG. 4, the EPE 114-1 may encapsulate the data packet 422 with the overlay label 420-B. The EPE 414-2 determines, based on the routing information 424-2, to send a decapsulated data packet 418 to the edge device 106. In some embodiments, each of the EPEs 114 may have a network connection with a plurality of other EPEs 114—for instance, the EPE 114-1 may also be communicatively coupled with the EPE 114-3 for sending data packets.

The VRF 102 is also configured to handle disruptions between the router 112 and the EPEs 114. For instance, the edge device 104 may send a data packet 418 addressed to the edge device 106 via the VRF system 102. The router 112 receives an encapsulated data packet 420 from the IPE 110 and selects EPE 114-3 as the next recipient of the data packet 420. However, the router 112 may detect that a network connection 630 (e.g., LDP/VPN tunnel) with the EPE 114-3 is disrupted or that the EPE 114-3 is unable to receive or process data packets—for instance, the EPE 114-3 may be powered off or may be offline for updates. The router 112 may detect a network disruption associated with the EPE 114-3 as a result of receiving a notification message from one of the EPEs 114 indicating the network disruption in the EPE 114-3 or in the network connection 630.

In previously implemented VRF systems, the ingress provider edge (or other entity of the VRF system) would recalculate MPLS routes through a VRF system as a result of detecting that the EPE 114-3 or the network connection 630 is unavailable. In the VRF system 102, by contrast, the router 112 uses the routing information 318 (corresponding to the label information 1500 of FIG. 5D) to select a different one of the EPEs 114 to send the data packet. The router 112 may select the EPE 114-2 having the same underlay label 508 as the EPE 114-3 based on the path information 504-1 as encapsulated by IPE by looking into FIG. 5D. In some embodiments, the router 112 forwards the data packet based on the LDP label 508 to one of the EPEs 114 available—in this particular example, the router 112 may forward the data packet to the EPE 114-2 based on the LDP label 508. The router 112 sends an encapsulated data packet 632 to the EPE 114-2, which decapsulates the data packet 632 and sends the data packet 418 to the edge device 106.

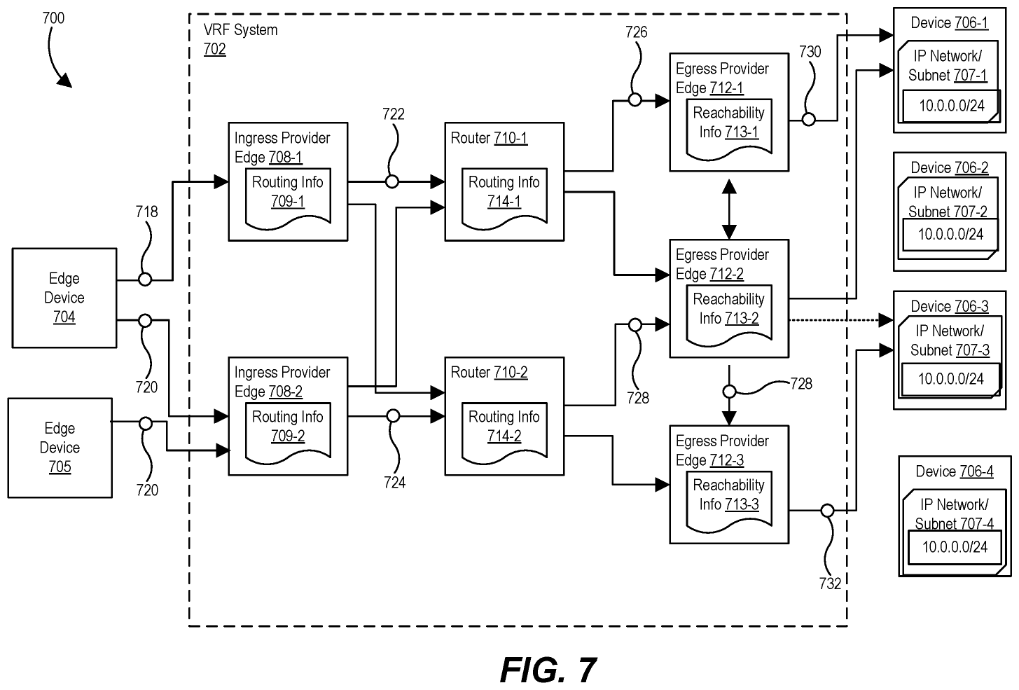

FIG. 7 illustrates an example network topology 700 in which a VRF system 702 mediates communications between multiple external edge devices according to one or more embodiments. The VRF system 702 maintains routing information for mediating communications from edge devices 704, 705 to one or more of a plurality of edge devices 706-1, 706-2, 706-3, and 706-4 (collectively “edge devices 706”). The VRF system 702 implements a plurality of routing instances wherein individual routing instances are between the edge device 704 and one of the edge devices 706. The VRF system 702 includes IPEs 708-1 and 708-2; routers 710-1 and 710-2; and EPEs 712-1, 712-2, and 712-3.

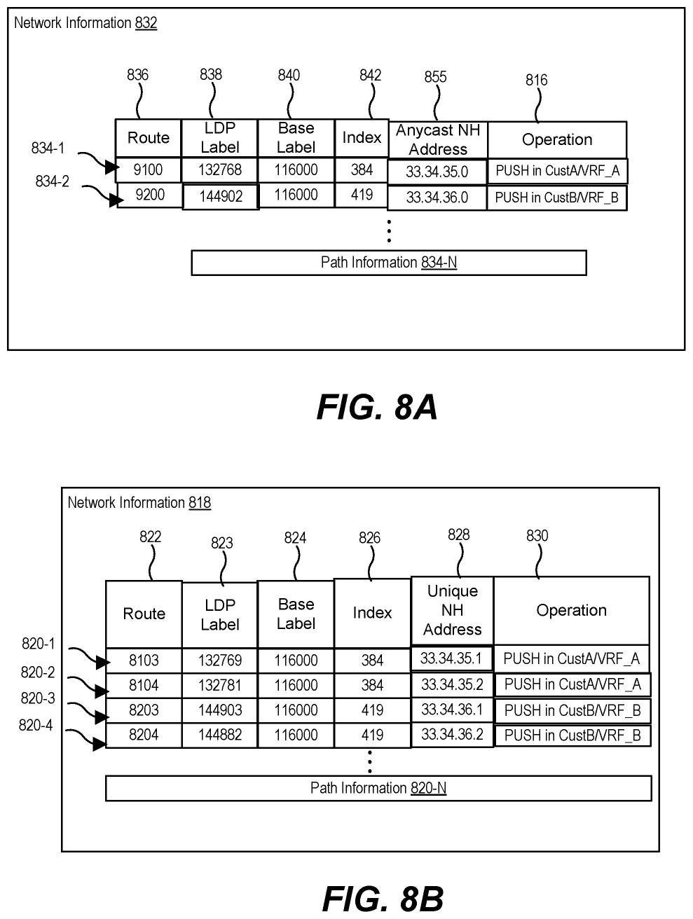

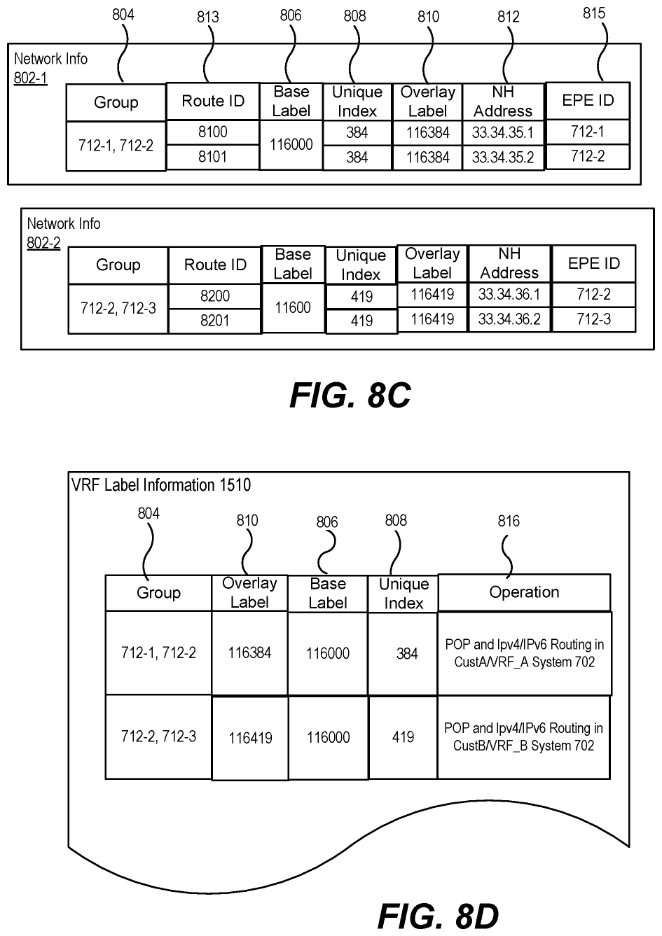

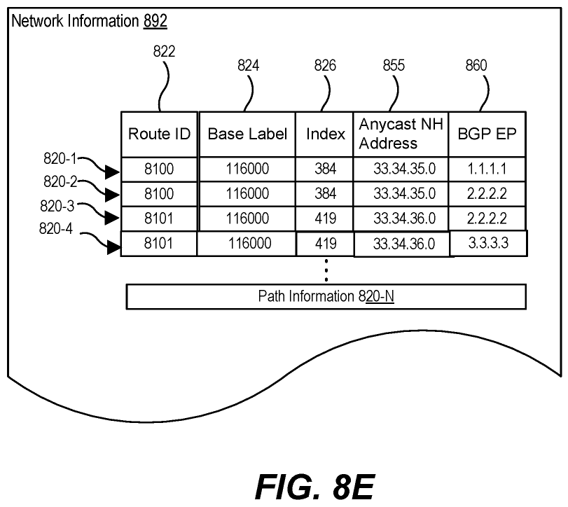

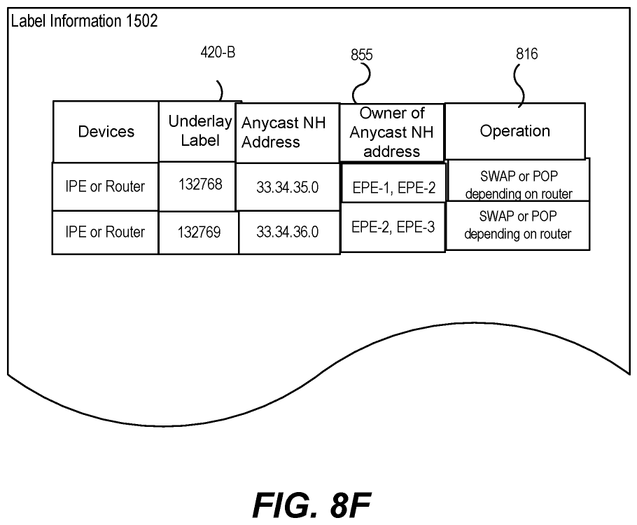

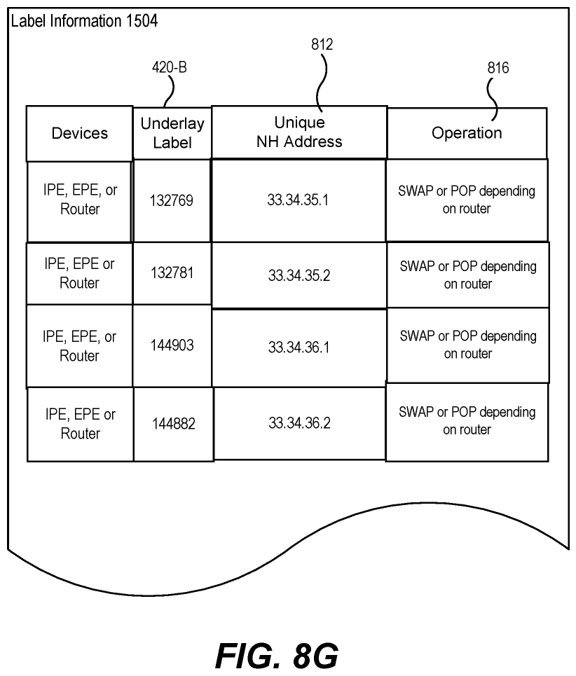

With reference to FIG. 8C, in the VRF system 702, groups or subsets of the EPEs 712 may be formed based on one or more routing strategies, such as ECMP techniques discussed herein. For instance, a first group of EPEs for communications with the edge devices 706-1 and 706-2 includes the EPEs 712-1 and 712-2 corresponding to customer A/VRF_A. A second group of EPEs for communications with the edge devices 706-3 and 706-4 includes the EPEs 712-2 and 712-3 corresponding to customer B/VRF_B.

The EPEs 712 communicate with each other to determine reachability information 713 to be advertised to peers in the VRF system 702 for communications to the edge devices 706. The routers 710-1 and 710-2 respectively generate routing information 714-1 and 714-2 based on the reachability information 713-1, 713-2, 713-3 advertised by the EPEs 712. The IPEs 708-1 and 708-2 respectively generate and store routing information 709-1 and 709-2 according to routing information provided by the routers 710-1 and 710-2, as described with respect to FIGS. 4, 5A, 5B, and elsewhere herein.

FIG. 8C illustrates reachability information generated by sets of the EPEs 712 based on communications between the EPEs 712. The EPEs 712-1 and 712-2 store, in memory, network information 802-1 regarding routes between the EPEs 712-1, 712-2 and the edge devices 706-1 and 706-2. The EPEs 712-2 and 712-3 store, in memory, network information 802-2 regarding routes between the EPEs 712-2, 712-3 and the edge devices 706-3 and 706-4.

The network information 802 may include reachability information and/or routing information, as described herein. The network information 802 will be exchanged between the group of associated EPEs operating in cooperation to route data packets to external edge devices corresponding to customers. The network information 802 includes a base label 806 common to the associated EPEs. The base label 806 useable to label data packets for forwarding to the associated EPEs in the VRF system 702. The network information 802 may include a unique but common index 808 associated with a particular VRF instance of the VRF system 702 to an external edge device. The unique index 808 is unique to the VRF instance or to a particular external edge device 706 but is common among a defined group of egress provider edge devices indicated in the group information 804, but 804 itself will not be part of 802 and used here just for the purpose of understanding. The same is applicable henceforth wherever mentioned. As a specific non-limiting example, the unique index 808 having a value of 384 is particular to the customer A/VFR A having one of the external edge devices 706-1 but is common among the group of EPE 712-1 and EPE 712-2 indicated in the group information 804. EPE 712-1 and EPE 712-2 use the unique index 808 in connection with network traffic in the VRF system 702 between the customer A/VRF_A having external edge devices 704 and one of the external edge devices 706-1. The network information 802 may include an overlay label 810 corresponding to a combination of the base label 806 and the unique index 808.

The network information 802 using the IBGP mesh is used to handle the network disruptions apart from advertising network information 518, and further includes a unique next-hop IP address 812 that the EPEs collectively determine in connection with the unique index 808. The network information 802 may include destination addresses 814 of one of the external edge devices 706. The network information 802 may include or indicate an action 830 in FIG. 8B to be performed on a data packet having an overlay or service label matching one of labels 810. Some of the network information 802 may be stored in different tables or arrays in some embodiments. The network information may include route ID 813 and EPE ID 815.

By way of example, the group information 804 in the network information 802-1 identifies the EPEs 712-1 and 712-2 as belonging to a group that coordinates to route data packets to customer A/VRF_A having external edge devices 706-1 and 706-2. The base label 806 of the network information 802-1 is advertised by the EPEs 712-1 and 712-2 for routing data packets to the customer A/VRF_A having edge devices 706-1 and 706-2. The network information 802-1 includes a unique index 808 with a value of 384 that is designated for data packets to be routed to customer A/VRF_A having the edge device 706-1/706-2.

The group information 804 in the network information 802-2 identifies the EPEs 712-2 and 712-3 as belonging to a group that coordinates to route data packets to customer B/VRF_B having external edge devices 706-3 and 706-4. The base label 806 of the network information 802-2 is advertised by the EPEs 712-2 and 712-3 for routing data packets to the customer B/VRF_B having edge devices 706-3 and 706-4. The network information 802-2 includes a unique index 808 with a value of 419 that is designated for data packets to be routed to the customer B/VRF_B having edge device 706-3/706-4. FIG. 8D further illustrates example label information 1510 that may be stored by an egress provider edge device 712-1, 712-2, 712-3 according to one or more embodiments. As shown in FIG. 8D, an overlay label 810 may be created by a combination of the base label 806 and the index 808. Based on the information in the overlay label 810, the EPE 712-1, 712-2, 712-3 will perform an operation 816, such as POP or IPv4/IPv6 routing in VRF system 702 (Customer A/VRF_A or Customer B/VRF_B).

FIG. 8B shows example network information 818 stored by EPEs of the VRF system 702 according to one or more embodiments. 8B is derived from 8C and 8G. The network information 818 may include reachability information and/or routing information, as described herein. The network information 818 may be stored in one or more routing tables or forwarding tables, each routing or forwarding table storing information for sending encapsulated data packets through a particular routing instance. The network information 818 includes a plurality of sets of path information 820-1, 820-2, . . . 820-N each associated with a particular path through one of the EPEs 712 to one of the edge devices 706. The path information 820-1 is associated with a path through EPE 712-1 to edge device 706-1 of customer A/VRF_A, the path information 820-2 is associated with a path through EPE 712-2 to edge device 706-1 of customer A/VRF_A, the path information 820-3 is associated with the path through EPE 712-2 to edge device 706-3 of customer B/VRF_B, and the path information 820-4 is associated with the path through EPE 712-3 to edge device 706-3 of customer B/VRF_B.

Each set of path information 820 includes a route 822, an LDP label 823, a base label 824, an index 826, a next-hop address 828, and an operation 830. The path information 820-1 and 820-2 shown in FIG. 8B includes some information that is substantially similar. The path information 820-3 and 820-4 shown in FIG. 8B includes some information that is substantially similar. The base labels 824, the index 826, and the next-hop address 828 respectively correspond to the base labels 806, the indexes 808, and the next-hop IP addresses 812 advertised by the EPEs 712. Each of the LDP labels 823 is specific to next-hop address 828.

FIG. 8E illustrates example network information 892 that may be stored by an IPE or RR/router according to one or more embodiments. The network information 892 may include reachability information and/or routing information, as described herein. The network information 892 includes one or more sets of path information 820-1, 820-2, 820-3, 820-4, . . . 820-N regarding LSPs established by the VRF system. The sets of path information 820-1, 820-2, 820-3, 820-4, . . . 820-N may each include a route identifier 822, a base label 824, an index 826, an anycast next-hop address 855, and/or a BGP endpoint identifier 860. The route identifier 822 is similar to 522. FIG. 8F illustrates LFIB label information 1502, similar to that shown in FIG. 5D. FIG. 8G illustrates label information 1504, including unique anycast NH address 812.

In some embodiments, the base label 824 and the index 826 may be combined into a single entry in each path information 820-1, 820-2, 820-3, 820-4, . . . 820-N. For instance, the path information 820-1, 820-2, 820-3, 820-4, . . . 820-N may each include a single entry in which the base label 824 is combined with the index 826, resulting in a value of 116384. The router 710 in the data path, in some implementations, performs load-balancing or forwards the data packet(s) received from the IPE 708 using the LDP label 838. In some embodiments, each instance of the path information 820 may include an identifier of one of the EPEs 712. An example of such an identifier is the BGP endpoint 860, which is tied with the unique next-hop addresses 209 discussed with respect to FIG. 2. The EPE identifier is useable by the router 710 to identify with which of the EPEs 712 the particular instance of the path information 820 is associated. For instance, the path information 820-1 may include an identifier associated with the EPE 712-1, the path information 820-2 may include an identifier associated with the EPE 712-2, and the path information 820-4 may include an identifier associated with the EPE 712-3. In some embodiments, the EPE identifier includes information specific to the individual EPE, such as a MAC address or a network segment identifier. The router 710 may use the EPE identifier to differentiate between the EPEs 712.

FIG. 8A shows example network information 832 stored by an ingress provider edge (e.g., IPEs 708) of a VRF system according to one or more embodiments. 8A is derived from 8E and 8F. The network information 832 may include reachability information and/or routing information, as described herein. The network information 832 may be stored in one or more routing tables or forwarding tables, each routing or forwarding table storing information for sending encapsulated data packets through a particular routing instance. The network information 832 includes a plurality of sets of path information 834-1, 834-2, 834-3, 834-4 . . . 834-N each associated with a particular VRF instance or path through one of the IPEs 708 to one of the edge devices 706.

Each set of the path information 834 includes a route 836, an LDP label 838, a base label 840, an index 842, and an anycast NH address 855, and an operation 816. In the network information 832, a single set of the path information 834 may correspond to a plurality of sets of the path information 820 stored by the routers 710. The LDP labels 838 are generated according to the Label Distribution Protocol, as described herein. Each LDP label 838 corresponds to one of the anycast next-hop addresses 855 of an EPE 712. The value of the LDP label distributed is outside the scope of this document but herein for brevity, on IPE anycast next-hop address 855 is chosen to be equidistant from the EPEs and will have the same value on the IPE. But depending on the deployment and protocols used, LDP label/LFIB could be same or different for the same anycast next-hop.

The IPEs 708 have a limited amount of storage locations for storing path information. For instance, in some implementations of a VRF system, an IPE would perform load-balancing operations to select a path among a plurality of paths of a route through the VRF system. The IPE, which may have sufficient memory space to store information for ˜N sets of ECMPs information, would store an instance of path information in memory for each path that includes an EPE. As a result, the amount of occupied memory of the IPE is proportional to the number of EPEs/VRFs of the VRF system if the EPEs are advertising a label per routing-instance/VRF.

By way of contrast, the IPE 708 stores a set of path information for each ECMP route through the VRF system 702. As shown in the network information 832 of FIG. 8A, the VRF instance having a route 836 value of 9100 is associated with two paths—a first path for the path information 820-1 and a second path for the path information 820-2 of network information 892. However, the IPE 708 stores a single set of path information 820-1 for the routing instance having the route 836 value of 9100. Advantageously, the amount of memory of the IPE 708 occupied to store routing information is significantly reduced relative to other VRF solutions in which IPEs may store an instance of path information for each path through an EPE. Hence ECMP resources will not be consumed for the overlay routes on the peer IPEs.

Operation of the VRF system 702 will now be described with reference to FIGS. 8A-8G. The edge device 704 sends, to the VRF system 702, a first data packet 718 addressed to the edge device 706-1. The IPE 708-1 receives the first data packet 718 and determines, based on the destination address in the first data packet 718 and the routing information 709-1, that the first data packet 718 should be encapsulated using the path information 834-1. More specifically, the IPE 708-1 encapsulates the first data packet 718 with an MPLS frame that includes an overlay label having a value 116384 corresponding to the base label 840 and index 842 in the path information 834-1. The IPE 708-1 also encapsulates the first data packet 718 with an underlay label having a value 132768 (corresponding to the LDP label 838 in the path information 834-1).

The IPE 708-1 sends an encapsulated data packet 722 having the MPLS frame, which is received by the router 710-1. The router 710-1 identifies the EPEs 712-1 and 712-2 as candidates for receiving the data packet 722 based on a match between the underlay label value 132768 of the data packet 722 and an LDP label 420-B of Label information 1502. Selection of one of the EPE 712-1 and the EPE 712-2 involves performance of an ECMP load-balancing technique, which is outside the scope of this document. For instance, the router 710-1 may select a hash key from among a plurality of stored hash keys and perform a hash function using the selected hash key to obtain a hash value. In this particular example, the router 710-1 selects the EPE 712-1 based on the resulting hash value. The router 710-1 removes the underlay of the data packet 722 based on the routing information 714-1 and forwards an encapsulated data packet 726 to the EPE 712-1. The data packet 726 has an overlay label value of 116384 corresponding to the overlay label value of the data packet 722.

The EPE 712-1 receives the data packet 726 and references routing information stored in the memory of the EPE 712-1 to determine how to process the data packet 726. The routing information stored by the EPE 712-1 includes at least some of the information in the network information 804 of VRF Label Information 1510. EPE 712-1 will route the packets as per 816 of VRF Label Information 1510 based on overlay label 810. The group information 804 and hence network information 818 will be used in the event that there is a disruption in a connection which would bring the BGP/IGP down, such as between EPE 712 and edge device 106.

The edge device 705 also sends, to the VRF system 702, a second data packet 720 addressed to the edge device 706-3. The IPE 708-2 receives the second data packet 720 and determines, based on the destination address in the second data packet 720 and the routing information 709-2, a data structure (e.g., a Forwarding Equivalence Class table), that the data packet should be encapsulated using the path information 834-2. The IPE 708-2 encapsulates the second data packet 720 with an MPLS frame that includes an overlay label having a value 116419 corresponding to the base label 840 and index 842 in the path information 834-3. The IPE 708-2 also encapsulates the second data packet 720 with an underlay label having a value 144902 (corresponding to the LDP label 838 in the path information 834-3).

The IPE 708-2 sends an encapsulated data packet 724 having the MPLS frame, which is received by the router 710-2. The router 710-2 identifies the EPEs 712-2 and 712-3 as candidates for receiving the data packet 724 based on a match between the underlay label value 144902 of the data packet and the LDP labels 420-B of label information 1502. The router 710-2 selects the EPE 712-2 based on a result of an ECMP load-balancing technique, as described herein. The router 710-2 removes the underlay of the data packet 724 and forwards an encapsulated data packet 728 to the EPE 712-2. The data packet 728 has an overlay label value of 116419.

The EPE 712-2 receives the data packet 728 and references routing information stored in the memory of the EPE 712-2 to determine how to process the data packet 728. The routing information stored by the EPE 712-2 includes at least some of the information in the network information similar to VRF label information 1510 but with a different anycast label 116419 associated with routing instance VFR_B described above with reference to the routing information stored by the EPE 712-1.

In this example, however, the EPE 712-2 may detect a network disruption in a connection between the EPE 712-2 and the edge device 706-3. As a result of detecting the disruption, the EPE 712-2 references the routing information to identify another EPE in the group associated with the underlay label value of 116419 or the unique next-hop address 33.34.36.2. For instance, as shown in the network information 802-2, and hence 820-4, the EPE 712-2 determines that the EPE 712-3 is included in a group associated with the label having the value 116419. The EPE 712-2 sends the data packet 728 to the EPE 712-3, which references routing information stored in its memory. With reference to FIG. 8D, based on a match between the label value 116419, followed by using 820-4 the network information 818 and route it towards 706-3 in routing instance VRF_B. EPE 712-3 removes the overlay or service label and sends an unencapsulated data packet 732 to the edge device 706-3 based on overlay label 116419 as per overlay label 810 of VRF Label information 1510. The data packet 732 includes a header and a payload that matches the second data packet 720 sent by the edge device 704.

The foregoing techniques involve generating, by a collection of EPEs, an anycast next hop identifier and an anycast MPLS identifier. The EPEs advertise the next hop identifier and the MPLS identifier to other network devices of a VRF system to facilitate a set of routing instances of a VRF system. The IPEs and routers of the VRF system use the anycast next hop identifier and the anycast MPLS identifier to implement a set of routing instances that comprise a plurality of MPLS network segments. Along with this, unique NHs with an anycast label would be advertised by the EPEs with other members of the EPE group with the IBGP mesh created between the group of EPEs to handle the network disruptions but with the same base label 210/806, and the index 212/808. This path will become active depending on the BGP best path algorithm (or when used as backup path) during link or node disruptions which would bring down BGP/IGP between EPE and an edge device. As a result of the features described herein, a VRF system may handle disruptions involving egress provider edges with improved efficiency. More particularly, VRF system entities (e.g., ingress provider edges, routers) do not incur a significant increase in ECMP software and/or hardware computing resources and packet losses are substantially reduced as a result of experiencing a disruption involving network segments that include the EPEs.

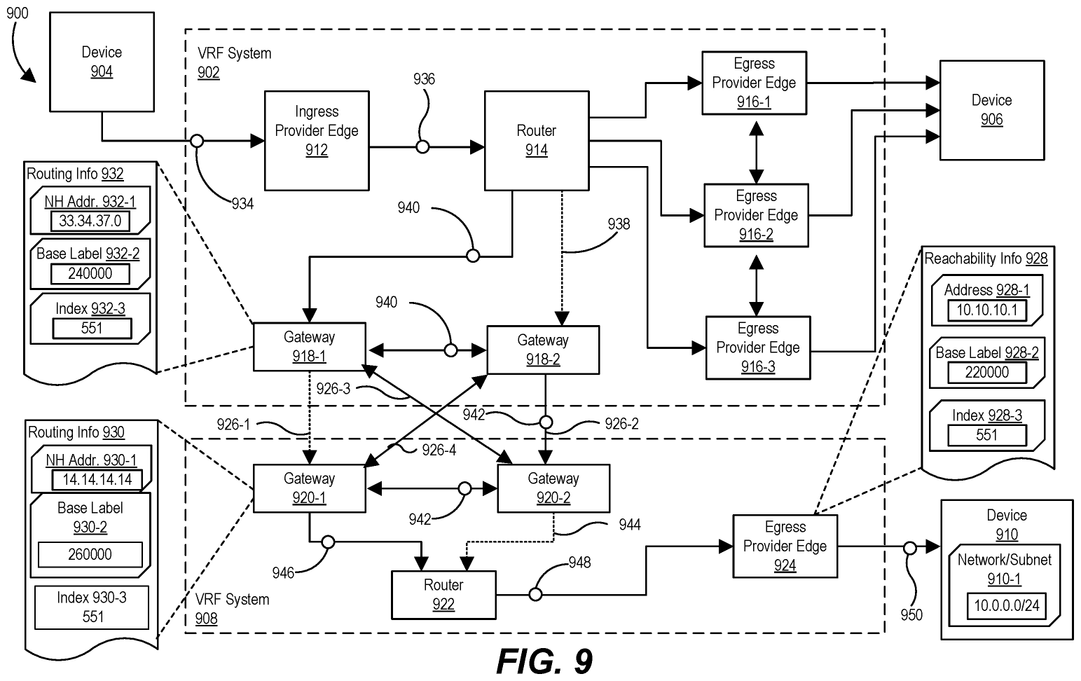

FIG. 9 illustrates a network topology 900 that includes a plurality of VRF systems according to one or more embodiments. The network topology 900 includes a VRF system 902 configured to provision a routing instance for mediating communications between external edge devices 904 and 906, as described herein. The network topology 900 also includes a VRF system 908 configured to mediate communications between the VRF system 902 and an external edge device 910. The external edge devices 904, 906 and 910 belong to the same customer. Various features of the network topology 900 are substantially similar to other network topologies described herein, so further description of such features is omitted for brevity including the IBGP mesh formed between EPEs with unique next-hops to handle various network and device disruptions. In this case IBGP mesh would be formed between ASBRs belong to the same AS to handle such network and device disruptions.

The VRF system 902 is separate from the VRF system 908. The VRF system 902 may be operated a first entity different from a second entity operating the VRF system 908. The first and second entities are separate entities that may provide one or more services, such as network services, internet service, and cloud or web-based services, by way of non-limiting example. The VRF system 902 operates on a different set of hardware and/or software than the VRF system 908 and may be located in a different building, campus, region, or country than the VRF system 908. In some embodiments, the hardware and/or software of the VRF systems 902 and 908 are isolated from each other except to convey communications between the edge device 910 and the edge device 904 and/or the edge device 906. For instance, the VRF system 902 may operate using a first set of administrative servers whereas the VRF system 908 operates using a second set of administrative servers different from the first set of administrative servers.

The VRF system 902 comprises an ingress provider edge 912, a router 914, and egress provider edges 916-1, 916-2, and 916-3, as described herein. The VRF system 902 also includes gateway devices 918-1 and 918-2 for interfacing with gateway devices of other VRF systems, such as the VRF system 908. The VRF system 908 comprises gateway devices 920-1 and 920-2, a router 922, and an egress provider edge device 924. Non-limiting examples of the router 914 and the router 922 include label switching routers, route reflectors, or other similar devices operating as intermediary nodes between edge devices (e.g., between IPE 912 and EPEs 916) or between gateway devices and provider edge devices (e.g., between IPE 912 and gateway devices 918, between gateway devices 920 and EPE 924). Non-limiting examples of the gateway devices include asynchronous system border routers (ASBRs) and/or area border routers (ABRs). In some embodiments, the VRF system 908 may include a plurality of EPEs 924 that operate as described with respect to FIGS. 2, 3, 4, and elsewhere herein.

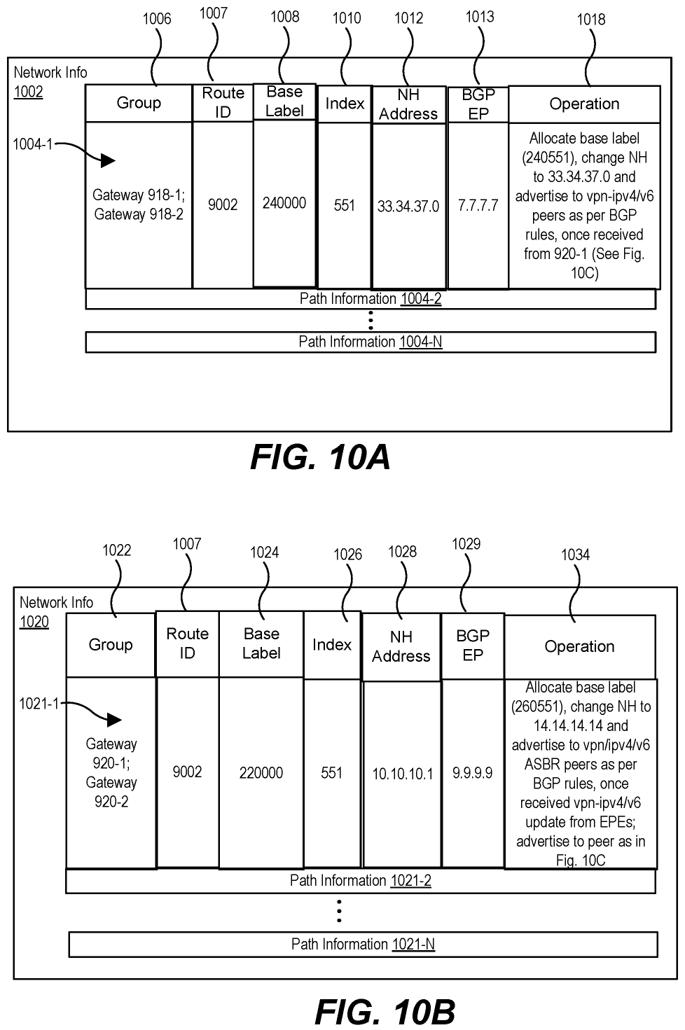

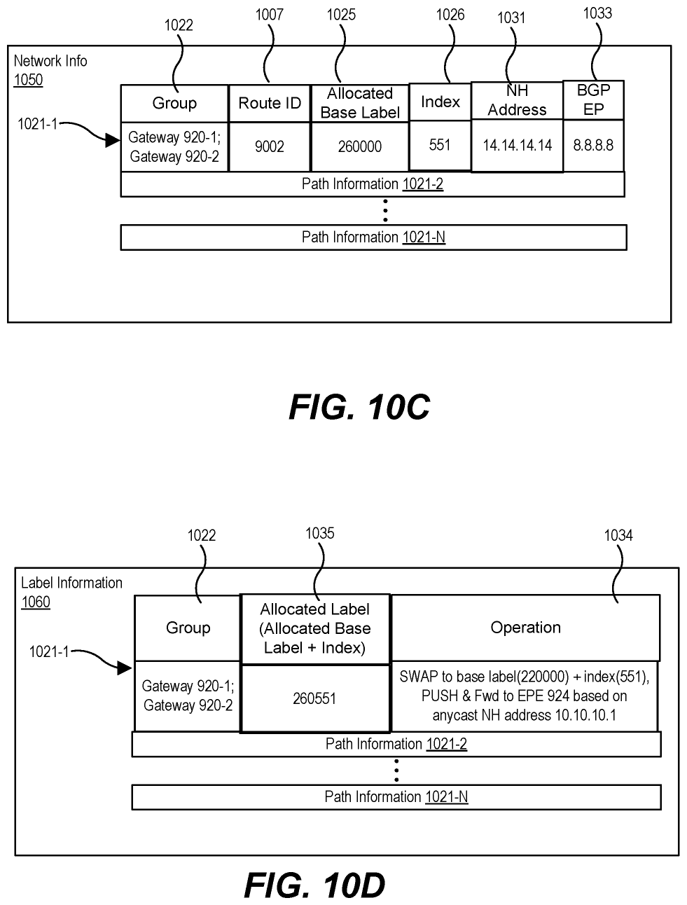

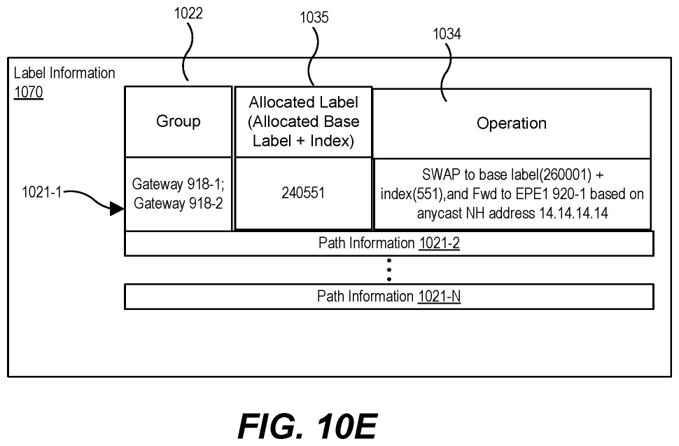

Network connections 926-1, 926-2, 926-3, and 926-4 are established between the VRF systems 902 and 908. A network connection 926-1 is established between the gateway 918-1 and the gateway 920-1, a network connection 926-2 is established between the gateway 918-2 and the gateway 920-2, a network connection 926-3 is established between the gateway 918-1 and the gateway 920-2, and a network connection 926-4 is established between the gateway 918-2 and the gateway 920-1. The network connections 926-1, 926-2, 926-3, and 926-4 are, in some embodiments, network tunnels established using MPLS techniques, such as a Resource Reservation Protocol for Traffic Engineering (RSVP-TE) protocol or a Multiprotocol External BGP (MP-EBGP) protocol. As a particular non-limiting example, one or both of the network connections 926-1, 926-2, 926-3 and/or 926-4 may be VPN tunnels. The gateway devices 918 and/or 920 are network devices, such as border routers (e.g., area boundary routers, autonomous system border routers). In some embodiments, the VRF system 902 and/or 908 may include more than two gateway devices for communications with other VRF systems. In an embodiment, a solution is provided to solve Inter-AS Option-B. As explained above, an Inter-AS Option-A and Option-C can be addressed with the embodiments discussed above. ASBRs will have a base label and a range per unique NH address present in the vpn-ipv4/v6 BGP advertisement. Only range needs to be provisioned thru cli or any means on ASBRs. So ASBRs will just swap the base labels from EPEs to ASBRs and vice-versa based on the NH. Index will remain the same. ASBRs will receive BGP VPN-ipv4/v6 network information from EPEs and peer AS ASBRs similar to as discussed with respect to FIG. 5B. From this ASBRs, will generate a table such as shown in FIG. 10A or FIG. 10B and advertise the BGP VPN-ipv4/v6 prefixes to peer AS ASBRs by swapping the vpn-ipv4/v6 labels (from the base label allocated based on the peer AS along with the index) and changing the NH. In an embodiment, ASBRs will install the locally allocated MPLS label in the LFIB ASBRs.

The gateway devices 918-1 and 918-2 communicate with the router 914 to facilitate communications with the edge device 910 communicatively coupled with the VRF system 908. The router 914 advertises the routing information provided by the gateway devices 918-1 and 918-2 to the IPE 912. For instance, the router 914 may advertise the IPE 912, a common anycast next hop address, and anycast Overlay/VRF/Service Label provided by ASBRs 918-1 and 918-2 which will forward the packets to ASBRs 920-1 and 920-2 which will eventually forward the packets to the edge device 910.

In the VRF system 908, the EPE 924 generates reachability information 928 for communications with the edge device 910. The reachability information 928 may include an anycast next-hop address 928-1 corresponding to an anycast IP address of a group of EPEs associated to mediate communications to the external edge device 910, as described with respect to the EPEs 204 of FIG. 2 and elsewhere herein. The reachability information 928 also includes a base label 928-2 having a value of 220000 and an index 928-3 having a value of 551. The next-hop address 928-1, the base label 928-2, and the index 928-3 correspond to those described with respect to FIG. 3 and elsewhere herein. The next-hop address 928-1, the base label 928-2, and the index 928-3 may be specific to and cooperatively determined among one or more other EPEs of the VRF system 908 and generates network information 928 similar to shown in FIG. 5B and advertises the same to router 922.

The EPE 924 advertises the reachability information 928 to the router 922. The router 922 advertises at least some of the reachability information 928 to the gateways 920-1 and 920-2. The gateways 920-1 and 920-2 generate the routing information 930.

In some embodiments, the label 260551 is a combination of a base label common to the gateways 920-1 and 920-2 and an index value specific to a peer VRF instance neighbor of the peer VRF system 902, as described with respect to the index 212 of FIG. 2 and elsewhere herein. For instance, the routing information 930 may include, for instance, an anycast next-hop address 930-1, a base label 930-2 specific to the group of gateways 920, and an index 930-3 corresponding to the NH 928-1 advertised by EPE-924. The reachability information stored and advertised by the gateways 920 may include an address of the 930-1 associated with itself (920), the base label 930-2, and the index 930-3. The actual label (260551) stored in LFIB as shown in FIG. 10D will be 930-2 (Allocated Base Label)+930-3 (Index).

The gateways 918-1 and 918-2 determine a set of network information for mediating communications between the VRF system 902 and the VRF system 908. The gateway devices 918-1 and 918-2 generate reachability information, as described with respect to FIGS. 2, 3, and elsewhere herein. At least some of the reachability information may be stored in routing information 932 in memory of the gateways 918. The routing information 932 may include, for instance, an anycast next-hop address 932-1, a base label 932-2 specific to the group of gateways 918, and an index 932-3 corresponding to the NH advertised by neighbor associated with the VRF system 908. The reachability information stored and advertised by the gateways 918 may include an address of the 932-1 associated with itself (918), the base label 932-2, and the index 932-3. The actual label (240551) stored in LFIB as shown in FIG. 10E will be 932-2 (Allocated Base Label)+932-3 (Index). The routing information 930 and/or the routing information 932 may include features and/or a format described with respect to the reachability information 206 and/or 802 respectively described with respect to FIGS. 2 and 8.

The router 914 generates and stores routing information as described with respect to the network information 518 and/or 818 respectively described with respect to FIG. 5B or 8B. The router 914 advertises at least some of the information included in the routing information 932 to the IPE 912. The IPE 912 generates and stores routing information as described with respect to the network information 502 and/or 832 respectively described with respect to FIG. 5A or 8A based on FIG. 5B or 8E it received.

Similarly, EPEs 916 or IPE 912 (which in this case will act as another EPE) would advertise prefixes to 918 thru router 914 which will reach 920 and then router 922 followed by EPE 924. All the operations described above will happen in the reverse direction as well if bi-directional communication is desired.

In operation of the network topology 900, the external edge device 904 may send a data packet 934 to the VRF system 902. The data packet 934 may be addressed to the external edge device 910 and received by the IPE 912. The IPE 912 references its routing information and encapsulates the data packet 934 to generate an encapsulated data packet 936. The encapsulated data packet 936 includes a first overlay corresponding to a combination of the base label 932-2 and the index 932-3 and includes a first underlay corresponding to an LDP label, as described with respect to FIGS. 4 through 5B and elsewhere herein. The IPE 912 sends the data packet 936 to the router 914. The router 914 removes the first underlay of the data packet 936 to reveal the first overlay and performs an ECMP load-balancing technique to select one of the gateways 918-1 and 918-2 to which to send the data packet.

An issue that may arise with respect to the network topology 900 is that network traffic through one of the gateways 918 may be disrupted. Consider, for example, a situation in which the router 914 determines that a network connection 938 with the gateway 918-2 is unavailable. In previous implementations, it would be difficult for the router 914 to effectuate delivery of the data packet to the VRF system 908 under such conditions. However, in the network topology 900, the router 914 would determine that another path is available to the VRF system 908 via the gateway 918-1. The router 914 would direct an encapsulated data packet 940 having the first overlay label.

A further potential issue that may arise with respect to the network topology 900 is that one of the network connections 926-1, 926-2, 926-3, and 926-4 between gateways 918 and 920 may be disrupted. For instance, the gateway 918-1 may receive the data packet 940 and determine, based on the first overlay label, that the data packet 940 should be processed and sent to the gateway 920-1. The gateway 918-1, however, may detect that the network connection 926-1 with the gateway 920-1 is unavailable or otherwise disrupted. In response to detecting the disruption of the network connection 926-1, the gateway 918-1 references routing information to determine how to proceed. In some embodiments, the gateway 918-1 then sends packet 940 from gateway to gateway 920-2 as described below.

FIG. 10A illustrates example network information 1002 stored in memory of a gateway device, such as the gateway devices 918-1 and 918-2, according to one or more embodiments. This is advertised to IPE 912. The network information 1002 may include reachability information and/or routing information, as described herein. More particularly, the network information 1002 includes one or more sets of path information 1004-1, 1004-2, . . . 1004-N regarding paths through the VRF system 902. The sets of path information 1004 may include group information 1006 identifying a group of associated gateways 918 of the VRF system 902 operating in cooperation to route data packets to gateway devices of other VRF systems. Group information 1006 is similar to group information 804 described earlier.

The network information 1002 includes a base label 1008, an index 1010, and an anycast next-hop IP address 1012 collectively generated by the gateways 918. The base label 1008, the index 1010, and the next-hop address 1012 may be generated in response to receiving network information 1050 from the gateways 920. The network information 1002 includes the Route ID and an MPLS label 240551 (Derived from 1008+1010) that's allocated locally on gateways 918 after receiving network information 1050 from the gateways 920 in connection with the Route ID. The network information 1002 may further include or indicate an operation 1018 to be performed for data packets received having an overlay label corresponding to a combination of the base label 1008 and the index 1010 as it generates label information 1070.

Referring back to FIG. 9, the gateway 918-2 compares the overlay or service label (240551) of the data packet 940 to the sets of label information 1021-1 of the label information 1070 of FIG. 10E derived from network information 1002 of FIG. 10A and network information 1020 of FIG. 10C. The gateway 918-2 identifies a match between the overlay label of the data packet 940 and the label information 1021-1 of the label information 1070. Based on the match, the gateway 918-2 determines that the data packet 940 should be processed and sent to the gateway 920-2. The gateway device 918-2 performs a SWAP operation based on the operation 1034 indicated to swap the overlay of the data packet 940 with the label (260551) in the label information 1070. The gateway device 918-2 sends a resulting encapsulated data packet 942 to the gateway device 920-2 of the VRF system 908.

The gateway 920-2 receives the data packet 942 and compares the overlay label of the data packet 942 to routing information stored in memory of the gateway 920-2. FIG. 10B illustrates example network information 1020 stored in memory of a gateway device, such as the gateway devices 920-1 and 920-2, according to one or more embodiments. The network information 1020 may include reachability information and/or routing information, as described herein. The network information 1020, more particularly, includes one or more sets of path information 1021-1, 1021-2, . . . 1021-N regarding paths through the VRF system 908.

The sets of path information 1021 may include group information 1022 identifying a group of associated gateways 920 of the VRF system 908 operating in cooperation to receive data packets from gateway devices of other VRF systems and route the data packets received through an appropriate path of the VRF system 908. The path information 1021 includes a base label 1024, an index 1026, and an anycast next-hop IP address 1028 advertised by the EPE 924 for routing data packets through the VRF system 908 to the edge device 910. The path information 1021 of network information 1050 may include an MPLS label 260000 (Derived from 1025+1026) advertised by the gateways 920 to gateways of other VRF systems, such as the gateways 918. Gateways 920 after receiving 10B from EPE 924, generates 10C and 10D. 10C is advertised to gateways 918 and labels as per 10D is installed locally on gateways 920 with the operation/action of swapping the overlay label from 260551 to 220551 and add an LDP label to reach the EPE 924 based on anycast NH address 10.10.10.1 as required. The same is mentioned in 1034 of 10D.

Referring back to FIG. 9, the gateway 920-2 compares the overlay or service label of the data packet 942 to the sets of label information 1021-1 of the label information 1060 of FIG. 10D which is generated after receiving 1021-1 of FIG. 10B from EPE-924. The gateway 920-2 identifies a match between the overlay label (260551) of the data packet 942 and the value (260551) of the label 1035 in the set of path information 1021-1 as in FIG. 10D. Based on the match, the gateway 920-2 that the data packet 942 should be sent to the router 922. More particularly, the gateway device 920-2 performs a SWAP operation specified in 1034, which involves swapping the overlay label with a label corresponding to a combination of the base label 1024 and the index 1026 (e.g., a label having a value of 220551 as per 10D which is derived from FIG. 10B). The gateway device 920-1 also performs a PUSH operation specified in 1034, which involves applying the LDP label 1032 in the path information 1021-1 as an underlay label of the data packet 946 (e.g., a label having a value of 230195). The gateway 920-1 sends the encapsulated data packet 946 to the router 922.

The router 922 references routing information stored in its memory, as described with respect to FIGS. 4 and 7, and pops the underlay (having the value 230195, let's say) of the data packet 946 to reveal the overlay label having the value 220551. The router 922 sends the data packet 948 having the overlay label to the EPE 924 based on the routing information. The EPE 924 receives the data packet 948, references routing information stored in its memory, and pops the overlay label of the data packet 948 based on the routing information, as described with respect to FIGS. 4, 7, and elsewhere herein. The EPE 924 sends a resulting data packet 950 having a destination address matching an address 910-1 to the edge device 910.

Advantageously, the features described herein improve the robustness of a VRF system against the disruption of network connections, both internal to the VRF system and external to the VRF system. The VRF system also reduces the impact of network disruptions to an ingress provider edge device by providing a common label and a common next hop address for the egress provider edge devices. When an egress provider edge node experiences an outage, for example, the routing instance identified in routing information of an ingress provider edge does not change, which improves convergence. With respect to gateway nodes between VRF systems of different entities, classifications for equal cost multi-path determinations are also reduced on importing border routing information. Furthermore, the label ranges for border devices, such as the gateways 918, can be configured by BGP peers, which improves scalability of a VRF system.

It is understood that the various embodiments described herein may be combined with other embodiments to achieve new embodiments. For example, the features of the network topology 900 may be combined with the features described with respect to the network topology 700 to realize benefits of both topologies. The network topologies described herein may be expanded to include a greater number of egress provider edges than three. Moreover, a VRF system described herein may include different sets of EPEs for implementing different routing instances. In a rare event wherein an ASBR is completely disconnected from all the devices of its local AS, it can bring down the link with the peer ASBRs which otherwise can blackhole the traffic.

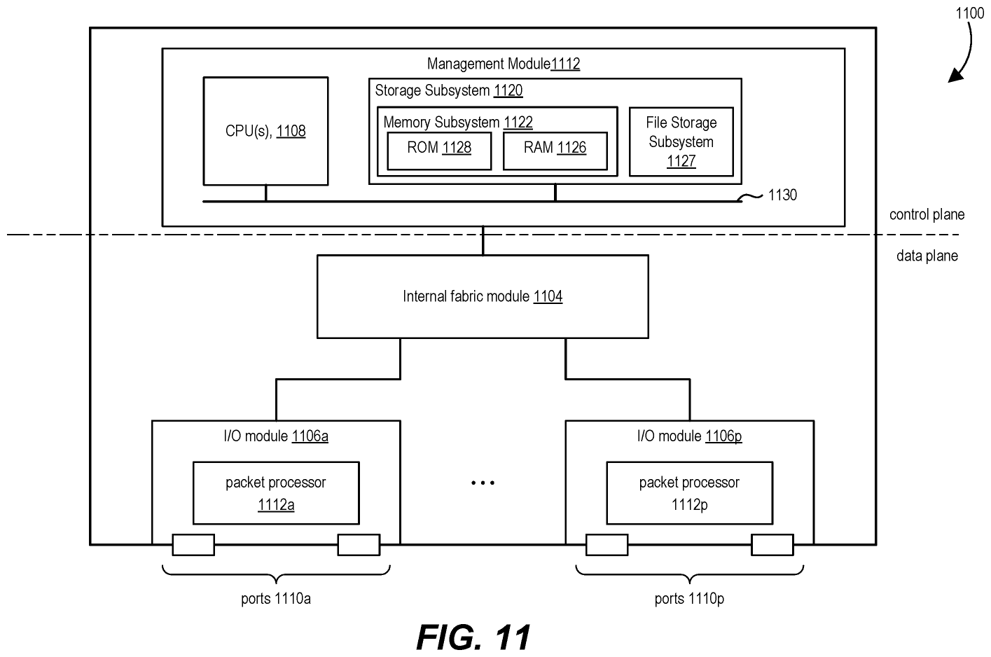

FIG. 11 illustrates a network device 1100 that is adapted to operate according to one or more embodiments of the present disclosure. The network device 1100 may be a switch or a router, for example. As shown, network device 1100 can include a management module 1112, an internal fabric module 1104, and a number of I/O modules 1106a-1106p. The management module 1112 may be disposed of in a control plane (also referred to as control layer) of the network device 1100 and can include one or more management CPUs 1108 for managing and controlling operation of network device 1100 in accordance with the present disclosure. Each management CPU 1108 can be a general-purpose processor, such as an Intel®/AMD® x86-64 or ARM® processor, that operates under the control of software stored in memory, such as a storage subsystem 1120 and memory subsystem 1122, which may include read-only memory 1128 and/or random-access memory 1126, and/or file storage subsystem 1127. In some embodiments, the CPU 1108 may include control circuitry, and may include or be coupled to a non-transitory storage medium storing encoded instructions that cause the CPU 1108 to perform operations described herein. In some embodiments, the non-transitory storage medium may include encoded logic or hardwired logic for controlling operation of the CPU 1108. The control plane refers to all the functions and processes that determine which path to use, such as routing protocols, spanning tree, and the like. Each network device 1100 can include multiple elements that may be electrically coupled via a bus 1130.

Internal fabric module 1104 and I/O modules 1106a-1106p collectively represent the data plane of network device 1100 (also referred to as data layer, forwarding plane, etc.). Internal fabric module 1104 is configured to interconnect the various other modules of network device 1100. Each I/O module 1106a-1106p includes one or more input/output ports 1110a-1110p that are used by network device 1100 to send and receive network packets. Each I/O module 1106a-1106p can also include a packet processor 1112a-1112p. Each packet processor 1112a-1112p can comprise a forwarding hardware component configured to make wire speed decisions on how to handle incoming (ingress) and outgoing (egress) network packets. In some embodiments, the forwarding hardware can comprise an application specific integrated circuit (ASIC), a field programmable array (FPGA), a digital processing unit, or other such collection of configured logic.

### Further Embodiments

In some aspects, the techniques described herein relate to a method including: receiving, by a first egress edge device of a Virtual Routing and Forwarding (VRF) system, an advertisement that includes a first identifier of a first external device external to the VRF system; communicating with a second egress edge device of the VRF system to determine a first base label value and a first index value, the first base label value being common to the first egress edge device and the second egress edge device, and the first index value being specific to the first external device; advertising, by the first egress edge device, the first identifier and the first base label value to one or more devices in the VRF system; receiving, by the first egress edge device, a first data packet encapsulated according to a Multi-Protocol Label Switching (MPLS) protocol; determining a first match between a first overlay label of the first data packet and a second label value corresponding to a combination of the first base label value and the first index value; performing a first set of operations to modify the first overlay label based on the first match; and sending the first data packet to the first external device.

In some aspects, the techniques described herein relate to a method, further including: communicating with the second egress edge device to determine a first anycast next-hop address common to the first egress edge device and the second egress edge device; and advertising the first anycast next-hop address to the one or more devices in the VRF system.

In some aspects, the techniques described herein relate to a method, further including: receiving, by the first egress edge device, a second data packet encapsulated according to the MPLS protocol; determining that a second overlay label of the second data packet matches the second label value; detecting a network disruption between the first egress edge device and the first external device; and in response to detecting the network disruption, sending the second data packet to the second egress edge device.

In some aspects, the techniques described herein relate to a method, further including: receiving, by the first egress edge device, a second data packet from the second egress edge device, the second data packet including a second overlay label; determining a second match between the second overlay label and the second label value; performing, as a result of determining the second match, the first set of operations further including: modifying the second overlay label based on the second match; and sending the second data packet to the first external device.

In some aspects, the techniques described herein relate to a method, wherein performing the first set of operations further includes removing the first overlay label.

In some aspects, the techniques described herein relate to a method, wherein performing the first set of operations further includes swapping the first overlay label with the first identifier.

In some aspects, the techniques described herein relate to a method, further including: receiving, by the first egress edge device, an advertisement that includes a second identifier of a second external device external to the VRF system; communicating with the second egress edge device to determine a second index value specific to the second external device; advertising the second index value to the one or more devices in the VRF system; receiving, by the first egress edge device, a second data packet encapsulated according to the MPLS protocol; determining a second match between a second overlay label of the second data packet and a third label value corresponding to a combination of the first base label value and the second index value; performing a second set of operations modifying the second overlay label based on the second match; and sending the second data packet to the second external device.

In some aspects, the techniques described herein relate to a first network device including: at least one memory; one or more network interfaces; and one or more processors configured to perform operations causing the first network device to: communicate with a second network device of a first Virtual Routing and Forwarding (VRF) system to determine a first base label value and a first index value, the first base label value being common between the first network device and the second network device, and the first index value being specific to a first external device external to the first VRF system; update routing information stored in the at least one memory to include a first set of path information associating the first base label value and the first index value with a first identifier of the first external device and with a second identifier of the second network device; receive a first data packet having a first overlay label; and send the first data packet to the first external device based on a first match between the first overlay label and a second label value corresponding to a combination of the first base label value and the first index value.

In some aspects, the techniques described herein relate to a first network device, wherein the one or more processors are further configured to perform operations causing the first network device to: communicate with a third network device of the first VRF system to determine a second base label value and a second index value, the second base label value being common between the first network device and the third network device, and the second index value being specific to a second external device external to the first VRF system; update the routing information to include a second set of path information associating the second label value and the second index value with a third identifier of the second external device and a fourth identifier of the third network device; receive a second data packet having a second overlay label; and send the second data packet to the second external device based on a second match between the second overlay label and a third label value corresponding to a combination of the first base label value and the second index value.

In some aspects, the techniques described herein relate to a first network device, wherein the first external device is a gateway device of a second VRF system, the first identifier is a label advertised by the gateway device, and the one or more processors are configured to replace the first overlay label with the first identifier as a result of the first match.

In some aspects, the techniques described herein relate to a first network device, wherein the first external device is a customer edge device, the first identifier is an address of the first external device, and the one or more processors are configured to remove the first overlay label as a result of the first match.

In some aspects, the techniques described herein relate to a first network device, wherein the one or more processors are further configured to store routing information in the at least one memory and to perform operations causing the first network device to: communicate with the second network device to determine a second index value specific to a second external device external to the first VRF system; update the routing information to include a second set of path information associating the first base label value and the second index value with the second identifier and with a third identifier of the second external device; receive a second data packet having a second overlay label; and send the second data packet to the second external device based on a second match between the second overlay label and a third label value corresponding to a combination of the first base label value and the second index value.

In some aspects, the techniques described herein relate to a first network device, wherein the one or more processors are further configured to perform operations causing the first network device to: receive a second data packet from a router of the first VRF system; determine a second match between a second overlay label of the second data packet and a third label value in the first set of path information; detect a disruption in a network connection with the first external device; and in response to detecting the disruption, send the second data packet to the second network device.

In some aspects, the techniques described herein relate to a first network device, wherein the one or more processors are further configured to perform operations causing the first network device to: receive, from the second network device, a second data packet that includes a second overlay label; determine a second match between a second overlay label of the second data packet and the second label value; remove, as a result of the second match, the second overlay label; and send the second data packet to the first external device.

In some aspects, the techniques described herein relate to a method including: receiving, by a first network device of a first Virtual Routing and Forwarding (VRF) system, first reachability information including a first address of a first edge device external to the first VRF system, a first base label associated with a first set of egress edge devices of the first VRF system, and a first index associated with the first set of egress edge devices; broadcasting an advertisement including the first address and a first label value generated according to a defined communication protocol; receiving, from a gateway device of a second VRF system, a first data packet including a first label; generating a modified data packet by at least replacing the first label with a second label corresponding to a combination of the first base label and the first index; and sending the modified data packet to a second network device in the first VRF system based on a match between a value of the first label and the first label value.

In some aspects, the techniques described herein relate to a method, wherein generating the modified data packet includes applying a third label to the first data packet, the defined communication protocol is a Border Gateway Protocol, the third label is generated according to a Label Switching Protocol, and the second network device is a Label Switched Router.

In some aspects, the techniques described herein relate to a method, including: receiving, from the gateway device of the second VRF system, a second data packet including the first label; detecting a network disruption between the first network device and the second network device; and sending the second packet to a third network device of the first VRF system as a result of detecting the network disruption.

In some aspects, the techniques described herein relate to a method, wherein the first network device is a gateway device of the first VRF system and the second network device is a Label Switching Router of the first VRF system.

In some aspects, the techniques described herein relate to a method, including: receiving, by the first network device, an anycast next-hop address corresponding to a set of egress edge devices of the first VRF system.

In some aspects, the techniques described herein relate to a method, including: updating routing information stored in a memory of the first network device to include a set of path information including group information in which the first network device and a third network device of the first VRF system are identified as belonging to a same network device group.

The various embodiments further can be implemented in a wide variety of operating environments, which in some cases can include one or more user computers, computing devices or processing devices which can be used to operate any of a number of applications. User or client devices can include any of a number of computers, such as desktop, laptop or tablet computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network. These devices may include virtual devices such as virtual machines, hypervisors and other virtual devices capable of communicating via a network.

Various embodiments of the present disclosure utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, and any combination thereof. In some embodiments, connection-oriented protocols may be used to communicate between network endpoints. Connection-oriented protocols (sometimes called connection-based protocols) are capable of transmitting data in an ordered stream. Connection-oriented protocols can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, Java servers, Apache servers, and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python or TCL, as well as combinations thereof. The server(s) may also include database servers, including without limitation those commercially available from Oracle®, Microsoft®, Sybase and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers, or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen, or keypad) and at least one output device (e.g., a display device, printer, or speaker). Such a system may also include one or more storage devices, such as disk drives, optical storage devices, and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. In addition, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members.

Conjunctive language, such as phrases of the form “at least one of A, B, and C,” or “one or more of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. In some embodiments, the code is stored on set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media may comprise multiple non-transitory computer-readable storage media and one or more of individual non-transitory storage media of the multiple non-transitory computer-readable storage media may lack all of the code while the multiple non-transitory computer-readable storage media collectively store all of the code. Further, in some examples, the executable instructions are executed such that different instructions are executed by different processors. As an illustrative example, a non-transitory computer-readable storage medium may store instructions. A main CPU may execute some of the instructions and a graphics processor unit may execute other of the instructions. Generally, different components of a computer system may have separate processors and different processors may execute different subsets of the instructions.

Accordingly, in some examples, computer systems are configured to implement one or more services that singly or collectively perform operations of processes described herein. Such computer systems may, for instance, be configured with applicable hardware and/or software that enable the performance of the operations. Further, computer systems that implement various embodiments of the present disclosure may, in some examples, be single devices and, in other examples, be distributed computer systems comprising multiple devices that operate differently such that the distributed computer system performs the operations described herein and such that a single device may not perform all operations.

The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

1. A method comprising:
receiving, by a first egress edge device of a Virtual Routing and Forwarding (VRF) system, an advertisement that includes a first identifier of a first external device external to the VRF system;
communicating with a second egress edge device of the VRF system to determine a first base label value and a first index value, the first base label value being common to the first egress edge device and the second egress edge device, and the first index value being specific to the first external device;
advertising, by the first egress edge device, the first identifier and the first base label value to one or more devices in the VRF system;
receiving, by the first egress edge device, a first data packet encapsulated according to a Multi-Protocol Label Switching (MPLS) protocol;
determining a first match between a first overlay label of the first data packet and a second label value corresponding to a combination of the first base label value and the first index value;
performing a first set of operations to modify the first overlay label based on the first match; and
sending the first data packet to the first external device.

2. The method of claim 1, further comprising:
communicating with the second egress edge device to determine a first anycast next-hop address common to the first egress edge device and the second egress edge device; and
advertising the first anycast next-hop address to the one or more devices in the VRF system.

3. The method of claim 1, further comprising:
receiving, by the first egress edge device, a second data packet encapsulated according to the MPLS protocol;
determining that a second overlay label of the second data packet matches the second label value;
detecting a network disruption between the first egress edge device and the first external device; and
in response to detecting the network disruption, sending the second data packet to the second egress edge device.

4. The method of claim 1, further comprising:
receiving, by the first egress edge device, a second data packet from the second egress edge device, the second data packet including a second overlay label;
determining a second match between the second overlay label and the second label value;
performing, as a result of determining the second match, the first set of operations further comprising:
modifying the second overlay label based on the second match; and
sending the second data packet to the first external device.

5. The method of claim 1, wherein performing the first set of operations further comprises removing the first overlay label.

6. The method of claim 1, wherein performing the first set of operations further comprises swapping the first overlay label with the first identifier.

7. The method of claim 1, further comprising:
receiving, by the first egress edge device, an advertisement that includes a second identifier of a second external device external to the VRF system;
communicating with the second egress edge device to determine a second index value specific to the second external device;
advertising the second index value to the one or more devices in the VRF system;
receiving, by the first egress edge device, a second data packet encapsulated according to the MPLS protocol;
determining a second match between a second overlay label of the second data packet and a third label value corresponding to a combination of the first base label value and the second index value;
performing a second set of operations modifying the second overlay label based on the second match; and
sending the second data packet to the second external device.

8. A first network device comprising:
at least one memory;
one or more network interfaces; and
one or more processors configured to perform operations causing the first network device to:
communicate with a second network device of a first Virtual Routing and Forwarding (VRF) system to determine a first base label value and a first index value, the first base label value being common between the first network device and the second network device, and the first index value being specific to a first external device external to the first VRF system;
update routing information stored in the at least one memory to include a first set of path information associating the first base label value and the first index value with a first identifier of the first external device and with a second identifier of the second network device;
receive a first data packet having a first overlay label; and
send the first data packet to the first external device based on a first match between the first overlay label and a second label value corresponding to a combination of the first base label value and the first index value.

9. The first network device of claim 8, wherein the one or more processors are further configured to perform operations causing the first network device to:
communicate with a third network device of the first VRF system to determine a second base label value and a second index value, the second base label value being common between the first network device and the third network device, and the second index value being specific to a second external device external to the first VRF system;
update the routing information to include a second set of path information associating the second label value and the second index value with a third identifier of the second external device and a fourth identifier of the third network device;
receive a second data packet having a second overlay label; and
send the second data packet to the second external device based on a second match between the second overlay label and a third label value corresponding to a combination of the first base label value and the second index value.

10. The first network device of claim 8, wherein the first external device is a gateway device of a second VRF system, the first identifier is a label advertised by the gateway device, and the one or more processors are configured to replace the first overlay label with the first identifier as a result of the first match.

11. The first network device of claim 8, wherein the first external device is a customer edge device, the first identifier is an address of the first external device, and the one or more processors are configured to remove the first overlay label as a result of the first match.

12. The first network device of claim 8, wherein the one or more processors are further configured to store routing information in the at least one memory and to perform operations causing the first network device to:
communicate with the second network device to determine a second index value specific to a second external device external to the first VRF system;
update the routing information to include a second set of path information associating the first base label value and the second index value with the second identifier and with a third identifier of the second external device;
receive a second data packet having a second overlay label; and
send the second data packet to the second external device based on a second match between the second overlay label and a third label value corresponding to a combination of the first base label value and the second index value.

13. The first network device of claim 8, wherein the one or more processors are further configured to perform operations causing the first network device to:
receive a second data packet from a router of the first VRF system;
determine a second match between a second overlay label of the second data packet and a third label value in the first set of path information;
detect a disruption in a network connection with the first external device; and
in response to detecting the disruption, send the second data packet to the second network device.

14. The first network device of claim 8, wherein the one or more processors are further configured to perform operations causing the first network device to:
receive, from the second network device, a second data packet that includes a second overlay label;
determine a second match between a second overlay label of the second data packet and the second label value;
remove, as a result of the second match, the second overlay label; and
send the second data packet to the first external device.

15. A method comprising:
receiving, by a first network device of a first Virtual Routing and Forwarding (VRF) system, first reachability information including a first address of a first edge device external to the first VRF system, a first base label associated with a first set of egress edge devices of the first VRF system, and a first index associated with the first set of egress edge devices;
broadcasting an advertisement including the first address and a first label value generated according to a defined communication protocol;
receiving, from a gateway device of a second VRF system, a first data packet including a first label;
generating a modified data packet by at least replacing the first label with a second label corresponding to a combination of the first base label and the first index; and
sending the modified data packet to a second network device in the first VRF system based on a match between a value of the first label and the first label value.

16. The method of claim 15, wherein generating the modified data packet includes applying a third label to the first data packet, the defined communication protocol is a Border Gateway Protocol, the third label is generated according to a Label Switching Protocol, and the second network device is a Label Switched Router.

17. The method of claim 15, comprising:
receiving, from the gateway device of the second VRF system, a second data packet including the first label;
detecting a network disruption between the first network device and the second network device; and
sending the second packet to a third network device of the first VRF system as a result of detecting the network disruption.

18. The method of claim 15, wherein the first network device is a gateway device of the first VRF system and the second network device is a Label Switching Router of the first VRF system.

19. The method of claim 15, comprising:
receiving, by the first network device, an anycast next-hop address corresponding to a set of egress edge devices of the first VRF system.

20. The method of claim 15, comprising:
updating routing information stored in a memory of the first network device to include a set of path information including group information in which the first network device and a third network device of the first VRF system are identified as belonging to a same network device group.
